(19) United States
(12) Patent Application Publication
(10) Pub. No.: US 2025/0247731 A1
(43) Pub. Date: Jul. 31, 2025

(54) UL ASSISTED MOBILITY

(71) Applicant: Samsung Electronics Co., Ltd., Suwon-si (KR)

(72) Inventors: Emad Nader Farag, Flanders, NJ (US); Aristides Papasakellariou, Houston, TX (US); Eko Onggosanusi, Coppell, TX (US)

(21) Appl. No.: 19/017,355

(22) Filed: Jan. 10, 2025

Related U.S. Application Data
(60) Provisional application No. 63/625,691, filed on Jan. 26, 2024.

(51) Int. Cl. H04W 24/10; H04W 74/0808

(52) U.S. Cl. CPC H04W 24/10; H04W 74/0808

(57) ABSTRACT

Methods and apparatuses for uplink (UL) assisted mobility. A method of operating a user equipment (UE) includes receiving one or more signals from one or more candidate cells, receiving, from a serving cell, information including configuration for a first communication element and association of the one or more signal with the first communication element, and receiving information for a first threshold. The method further includes measuring first reference signal received powers (RSRPs) for each of the one or more signals, evaluating a condition based on the first RSRPs and the first threshold, and when the condition is satisfied, transmitting the first communication element to a corresponding one of the one or more candidate cells.

### CROSS-REFERENCE TO RELATED AND CLAIM OF PRIORITY

The present application claims priority under 35 U.S.C. § 119 (e) to U.S. Provisional Patent Application No. 63/625,691 filed on Jan. 26, 2024, which is hereby incorporated by reference in its entirety.

### TECHNICAL FIELD

The present disclosure relates generally to wireless communication systems and, more specifically, the present disclosure relates to methods and apparatuses for uplink (UL) assisted mobility.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UL assisted mobility.

In one embodiment, a user equipment (UE) is provided. The UE includes a transceiver configured to receive one or more signals from one or more candidate cells, receive, from a serving cell, information including configuration for a first communication element and association of the one or more signals with the first communication element and receive information for a first threshold. The UE further includes a processor operably coupled to the transceiver. The processor is configured to measure first reference signal received powers (RSRPs) for each of the one or more signals and evaluate a condition based on the first RSRPs and the first threshold. The transceiver is further configured to transmit, when the condition is satisfied, the first communication element to a corresponding one of the one or more candidate cells.

In another embodiment, a base station (BS) system is provided. The BS system includes one or more candidate BSs comprising one or more transceivers, respectively, configured to transmit one or more signals, respectively, from one or more candidate cells, respectively, and a serving BS comprising a transceiver and a processor operably coupled with the transceiver. The transceiver of the serving BS is configured to transmit, from a serving cell, information including configuration for a first communication element and association of the one or more signal with the first communication element and transmit information for a first threshold. When a condition based on the first threshold is satisfied, one of the one or more transceivers of the one or more candidate BSs is further configured to receive the first communication element on a corresponding one of the one or more candidate cells. The processor of the serving BS is configured to, based on measurement of the first communication element, determine whether or not to perform handover to one of the one or more candidate cells.

In yet another embodiment, a method of operating a UE is provided. The method includes receiving one or more signals from one or more candidate cells, receiving, from a serving cell, information including configuration for a first communication element and association of the one or more signal with the first communication element, and receiving information for a first threshold. The method further includes measuring first RSRPs for each of the one or more signals, evaluating a condition based on the first RSRPs and the first threshold, and when the condition is satisfied, transmitting the first communication element to a corresponding one of the one or more candidate cells.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example synchronization signal/physical broadcast channel (SS/PBCH) block according to embodiments of the present disclosure;

FIG. 8A illustrates a flowchart of an example contention based random access (CBRA) procedure according to embodiments of the present disclosure;

FIG. 8B illustrates a flowchart of an example contention free random access (CFRA) procedure according to embodiments of the present disclosure;

FIG. 9A illustrates a flowchart of an example CBRA procedure according to embodiments of the present disclosure;

FIG. 9B illustrates a flowchart of an example CFRA procedure according to embodiments of the present disclosure;

FIG. 10 illustrates a flowchart of an example procedure for UL resource transmission according to embodiments of the present disclosure;

FIG. 11 illustrates a diagram of an example UL transmission according to embodiments of the present disclosure;

FIG. 12 illustrates a diagram of an example UL and downlink (DL) transmission according to embodiments of the present disclosure;

FIG. 13 illustrates a diagram of an example UL transmission according to embodiments of the present disclosure;

FIG. 14 illustrates a flowchart of an example procedure for UL resource transmission according to embodiments of the present disclosure; and

FIG. 15 illustrates a flowchart of an example procedure for UL resource transmission according to embodiments of the present disclosure.

### DETAILED DESCRIPTION

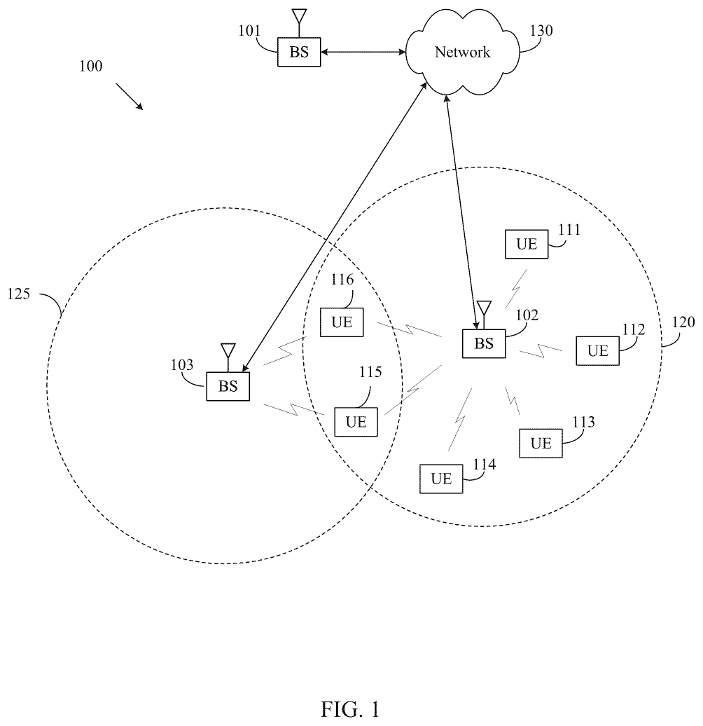

FIGS. 1-15, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 38.211 v18.1.0, “NR; Physical channels and modulation;” [REF2] 3GPP TS 38.212 v18.1.0, “NR; Multiplexing and Channel coding;” [REF3] 3GPP TS 38.213 v18.1.0, “NR; Physical Layer Procedures for Control;” [REF4] 3GPP TS 38.214 v18.1.0, “NR; Physical Layer Procedures for Data;” [REF5] 3GPP TS 38.321 v18.0.0, “NR; Medium Access Control (MAC) protocol specification;” and [REF6] 3GPP TS 38.331 v18.0.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for UL assisted mobility. In certain embodiments, one or more of the gNBs 101-103 include circuitry, programing, or a combination thereof to support UL assisted mobility.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

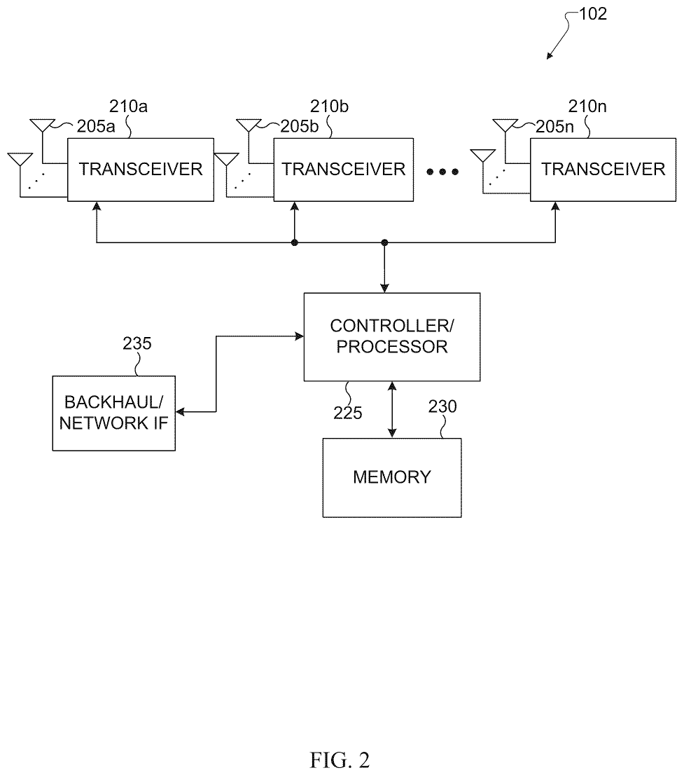

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting UL assisted mobility. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

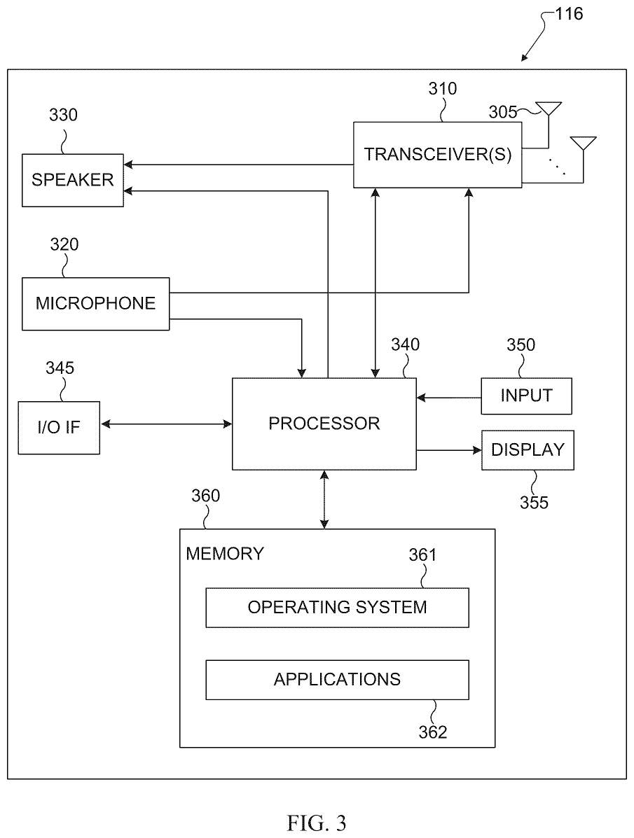

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify UL assisted mobility as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUS). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

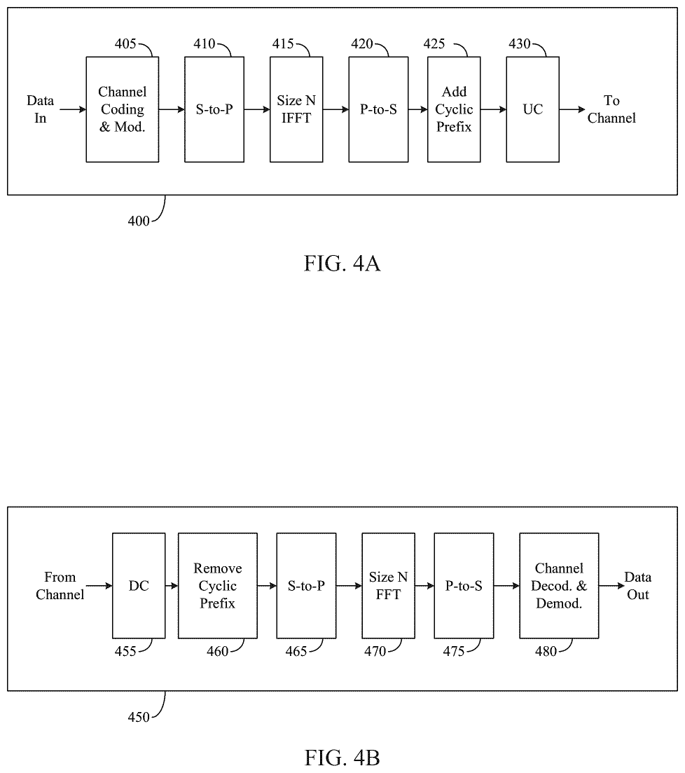

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 performs actions for UL assisted mobility as described in embodiments of the present disclosure. In some embodiments, the receive path 450 performs actions for UL assisted mobility as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

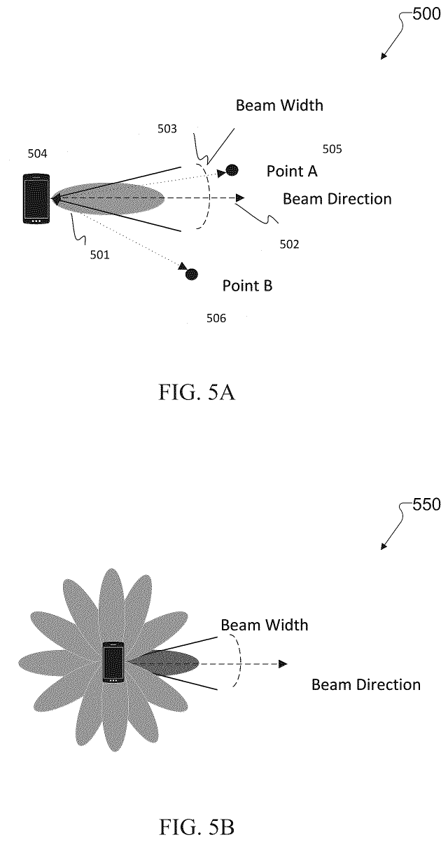

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

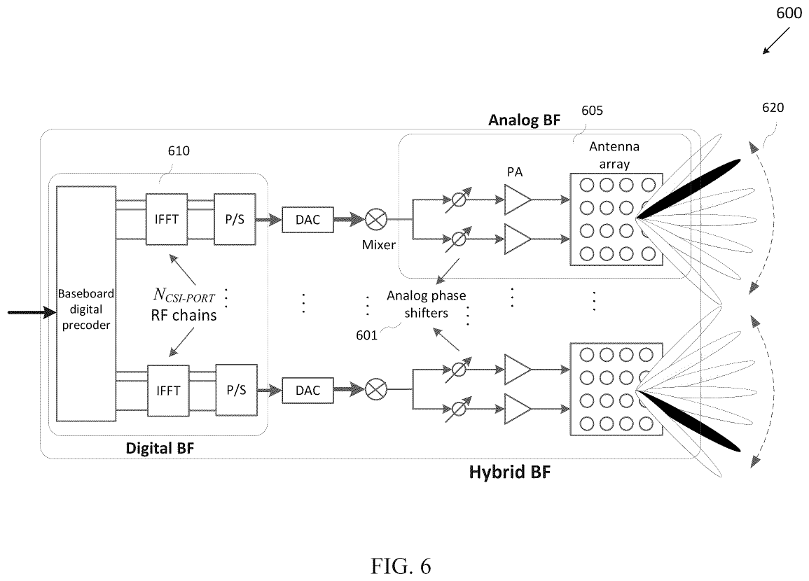

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while the figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam can be determined by any of;
A transmission configuration indication (TCI) state, that establishes a quasi-colocation (QCL) relationship or spatial relation between a source reference signal (e.g. synchronization signal block (SSB) and/or CSI-RS) and a target reference signal
A spatial relation information that establishes an association to a source reference signal, such as SSB or CSI-RS or SRS.

In either case, the ID of the source reference signal or the ID of the TCI state or the ID of the spatial relation identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB (e.g., the BS 102), or a spatial Rx filter for reception of uplink channels at the gNB.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE (e.g., the UE 116) is indicated a TCI state by MAC CE when the CE activates one TCI state code point. The UE applies the TCI state code point after a beam application time from the corresponding hybrid automatic repeat request acknowledgement (HARQ-ACK) feedback. A UE is indicated a TCI state by a DL related downlink control information (DCI) format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

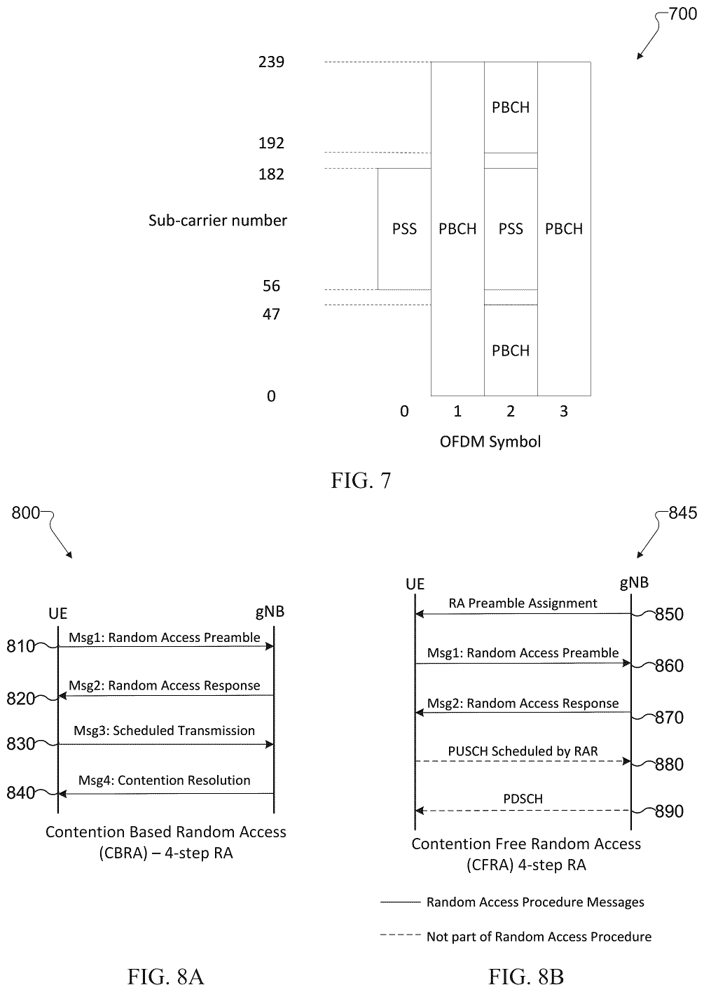

FIG. 7 illustrates a diagram of an example SS/PBCH block 700 according to embodiments of the present disclosure. For example, SS/PBCH block 700 can be utilized by any of the UEs 111-116 of FIG. 1. This example is for illustration only and other embodiments can be used without departing from the scope of the present disclosure.

In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). With reference to FIG. 7, a primary synchronization signal (PSS)/secondary synchronization signal (SSS)/PBCH block (SS/PBCH block) is referred to as SSB and includes 4 consecutive symbols, and 20 physical blocks (240 subcarriers).

SSBs are organized in groups (or bursts) of up to N SSBs, transmitted within half a frame (5 ms), each SSB within the group has an index i, where i=0, 1, . . . , N−1, within each group of SSBs, the SSBs are time-division multiplexed and arranged in increasing order of i, with increasing time. For carrier frequencies less than or equal to 3 GHZ, N=4. For carrier frequencies in FR1 that are larger than 3 GHz, N=8. For carrier frequencies in FR2, N=64. The SSB indices transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network (e.g., the network 130) and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz, and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of physical resource blocks (PRBs)) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of TS 38.211 v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {1/8,1/4,1/2,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [38.213 v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

FIG. 8A illustrates a flowchart of an example contention-based random access (CBRA) procedure 800 according to embodiments of the present disclosure. For example, CBRA procedure 800 can be performed by the UE 116 and the gNB 102 and/or network 130 in the wireless network 100 of FIG. 1. This example is for illustration only and other embodiments can be used without departing from the scope of the present disclosure.

The procedure begins in 810, a UE transmits a Msg1: random access preamble to a gNB. In 820, the gNB transmits a Msg2: random access response to the UE. In 830, the UE transmits a Msg3: scheduled transmission to the gNB. In 840, the gNB transmits Msg4: content resolution to the UE.

FIG. 8B illustrates a flowchart of an example contention-free random access (CFRA) procedure 845 according to embodiments of the present disclosure. For example, CFRA procedure 845 can be performed by the UE 116 and the gNB 103 and/or network 130 in the wireless network 100 of FIG. 1. This example is for illustration only and other embodiments can be used without departing from the scope of the present disclosure.

The procedure begins in 850, a gNB transmits a RA preamble assignment to a UE. In 860, the UE transmits a Msg1: random access preamble to the gNB. In 870, the gNB transmits a Msg2: random access response to the UE. In 880, the UE may transmit a PUSCH scheduled by random access response (RAR) to the gNB. In 890, gNB may transmit PDSCH to the UE.

A random access procedure can be initiated by a PDCCH order, by the MAC entity, or by RRC.

There are two types of random access procedures, type-1 random access procedure and type-2 random access procedure.

With reference to FIG. 8, Type-1 random access procedure also known as four-step random access procedure (4-step RACH) is shown;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and an uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC reconfiguration complete message.
In step 4, the gNB upon receiving the RRC reconfiguration complete message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

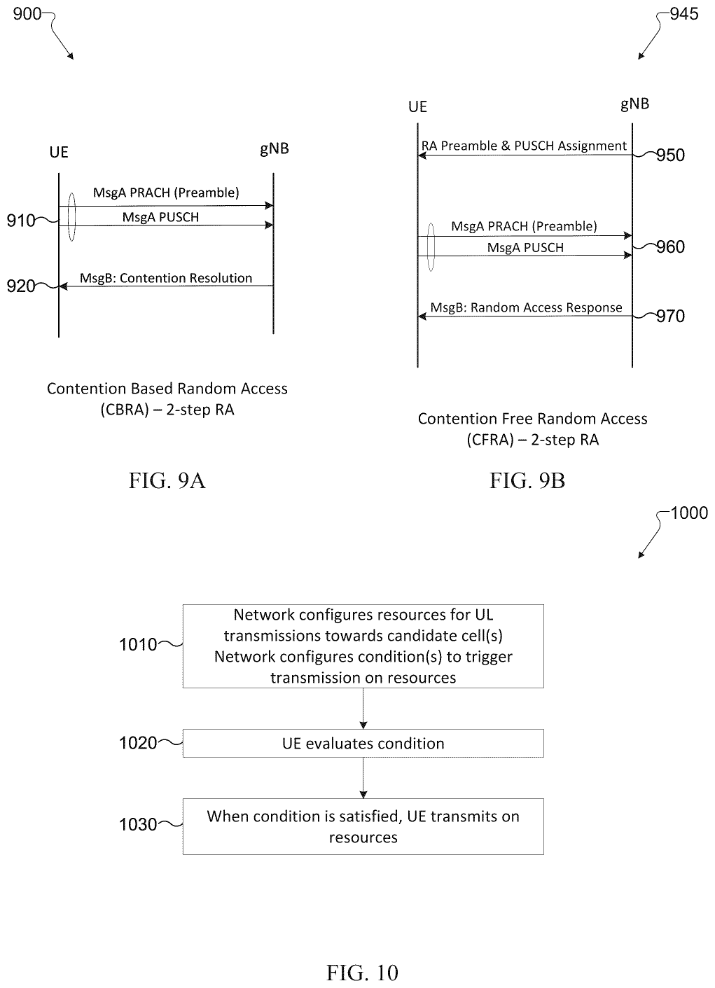

FIG. 9A illustrates a flowchart of an example CBRA procedure 900 according to embodiments of the present disclosure. For example, CBRA procedure 900 can be performed by the UE 115 and the gNB 102 and/or network 130 in the wireless network 100 of FIG. 1. This example is for illustration only and other embodiments can be used without departing from the scope of the present disclosure.

The procedure begins in 910, a UE transmits MsgA PRACH (preamble) and MsgA PUSCH to a gNB. In 920, the gNB transmits MsgB: contention resolution to the UE.

FIG. 9B illustrates a flowchart of an example CFRA procedure 945 according to embodiments of the present disclosure. For example, CFRA procedure 945 can be performed by the UE 115 and the gNB 103 and/or network 130 in the wireless network 100 of FIG. 1. This example is for illustration only and other embodiments can be used without departing from the scope of the present disclosure.

The procedure begins in 950, a gNB transmits a RA preamble and PUSCH assignment to a UE. In 960, the UE transmits MsgA PRACH (preamble) and MsgA PUSCH to the gNB. In 970, the gNB transmits MsgB: random access response to the UE.

Release 16 introduced a new random access procedure; Type-2 random access procedure, also known as 2-step random access procedure (2-step RACH), with reference to FIG. 9, that combines the preamble and PUSCH transmission into a single transmission from the UE to the gNB, which is known as MsgA. Similarly, the RAR and the PDSCH transmission (e.g., Msg4) are combined into a single downlink transmission from the gNB to the UE, which is known as MsgB.

A random access procedure can be triggered for initial access from the RRC IDLE state. During this procedure, a UE identifies an SS/PBCH block with index i and with an reference signal received power (RSRP) that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with cyclic redundancy check (CRC) scrambled by a corresponding random access radio network temporary identifier (RA-RNTI) during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a C-RNTI, the UE attempts to detect a DCI format 1_0 with CRC scrambled by a corresponding temporary cell-radio network temporary identifier (TC-RNTI) scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

In NR/5G as a UE in RRC_CONNECTED mode moves around, it can connect to the network through different cells or different beams. There are two types of network controlled mobility procedures for UEs in RRC_CONNECTED mode: (1) Cell Level Mobility, also referred to as handover, this requires RRC signaling to be triggered and UE changes its serving cell from a source serving cell to a target serving cell. (2) Beam Level Mobility, which includes intra-cell beam level mobility and inter-cell beam level mobility, this doesn't require explicit RRC signaling to be triggered. To improve handover procedures 3GPP introduce several handover enhancements which include:
Dual Active Protocol Stack (DAPS): The source gNB connection is maintained, i.e., UE continues DL user data reception with the source gNB and UL user data transmission to the source gNB, after reception of the RRC message for handover, and until source cell is released after successful random access to the target gNB.
Conditional Handover (CHO): RRC configures handover parameters, however, the handover procedure is not executed by the UE until certain condition(s) are met at the UE. The UE evaluates the execution condition(s) upon receiving the CHO configuration, and stops evaluating the execution condition(s) once a handover is executed. The execution condition
L1/L2 Triggered Mobility (LTM). The gNB prepares and provides candidate cell configuration to the UE. The physical layer provides measurement reports that include RSRP of SSB beams of candidate cells. Based on the measurement reports, the gNB (e.g., the BS 102) can change the serving cell to a target cell through a cell switch command signaled via MAC CE. The UE switches to the target cell following the cell switch command. The benefit of cell switch command is to reduce handover latency.

Handover is executed or triggered based on DL coverage conditions at the UE, for example when measurements (e.g., RSRP, reference signal received quality (RSRQ) or SINR) based on downlink signals (e.g., SS/PBCH block or channel state information reference signal (CSI-RS)) of the target cell and the source cell meet a certain condition. The condition and state of the UL channel is not evaluated in the handover decision. In some scenarios, the UL traffic is dominant, for example, for non-smartphone applications and XR applications. In those cases, it would be beneficial to evaluate the UL channel condition when making the handover or mobility decision.

In this disclosure, transmission of UL signals or channels to candidate cell(s) to assist with handover (mobility) decisions are evaluated. UL signals, for example, can include sounding reference signal (SRS) or physical random access channel (PRACH). The transmission of such UL signals or channels to candidate cell(s) allows the network to evaluate the UL channel condition between UE and the candidate cell(s), and make handover or mobility decisions based on these measurements.

In 5G/NR mobility procedures are essential to maintaining the connection as a UE moves around within the network's coverage area. Cell level mobility (e.g., handover), requires RRC signaling to be triggered to configured candidate cells, and handover conditions. When the handover conditions are satisfied, cell level mobility (e.g., handover) is executed. On the other hand, beam level mobility, which can be intra-cell or inter-cell, doesn't require RRC to be triggered and is performed based on physical layer measurements. The measurements are performed at the UE base on signals (e.g., SS/PBCH blocks or CSI-RS) transmitted from the source cell and candidate cells(s). These measurements evaluate the downlink coverage conditions. Embodiments of the present disclosure recognize that these measurements don't take uplink coverage or uplink channel conditions into account. In some scenarios, the UL traffic is dominant, for example, for non-smartphone applications and XR applications. In those cases, it would be beneficial to evaluate the UL channel when making the handover or mobility decision. Furthermore, in some network deployments there can be TRPs that only support UL receptions, it would be beneficial to evaluate UL channel conditions for mobility decisions involving the UL TRPs. This motivates the transmission of UL signals to candidate cell(s) or candidate TRP(s) to evaluate the UL channel condition for mobility.

In this disclosure, transmission of UL signals or channels to candidate cell(s) to assist with handover (mobility) decisions is evaluated. UL signals, for example, can include sounding reference signal (SRS) or physical random access channel (PRACH). The transmission of such UL signals or channels to candidate cell(s) allows the network to evaluate the UL channel condition between UE and the candidate cell(s), and make handover or mobility decisions based on these measurements.

The present disclosure relates to a 5G/NR and/or 6G communication system.

This disclosure evaluates aspects related to design of UL reference signals to candidate cells to assist with mobility decisions:
UE initiated or triggered UL signal transmission to candidate cells.
UE requested UL signal transmission to candidate cells.
Network triggered UL signal transmission to candidate cells.

In this disclosure, the following embodiments are evaluated:

In one embodiment, a UE initiates UL transmission for channel sounding/beam identification towards candidate cell or cells when a condition is satisfied.
Step 1:
   Network configures resources a UE can use for UL transmission towards candidate cell.
   Network configures a condition to trigger the transmission of these resources.
Step 2: UE evaluates condition. Example of conditions can include:
   Cell specific RSRP, RSRQ or SINR threshold. Network can update the threshold dynamically, for example based on UL load of the cell.
Step 3: UE transmits UL transmission.
   In one example, the UE can estimate the TA for the UL transmission, for example, if the UL transmission is SRS. In another example, the cells are in the same TAG.
   In one example, the UL transmission is SRS. In one example, SRS can be preceded by pre-notification as described herein.
   In one example, the UL transmission is PRACH.
   In one example, the UL transmission can be PRACH+SRS. In one example, PRACH can be used to estimate TA and signal to UE through RAR.
   UL transmission can be aperiodic (one shot or N shots), or UL transmission can be semi-persistent (can be deactivated at a future time by the network or by the UE).

In one embodiment, a UE initiates a SR towards serving or candidate cell for the network to trigger UL transmission for channel sounding/beam identification for one or more candidate cells.
Step 1:
   Network configures resources a UE can use for UL transmission towards candidate cell.
   Network configures scheduling request resources associated with candidate cell.
   Network configures a condition to trigger the transmission of these resources
Step 2: UE evaluates condition. Example of conditions can include:
   Cell specific RSRP, RSRQ or SINR threshold. Network can update the threshold dynamically, for example based on UL load of the cell
Step 3: UE sends scheduling request towards serving cell or a candidate cell.
   In one example, the UE can estimate the TA for the UL SR (e.g., on PUCCH) to the candidate cell. In another example, the cells are in the same TAG.
   SR can indicate a quantized range of RSRP or RSRQ or SINR. For example, different SR resources for each quantized range.
   SR can indicate candidate cell associated with request when SR is sent to serving cell. In one example, this can be implicitly determined by resource of SR.
   SR can be a preamble or SR on PUCCH
Step 4: Network triggers UL transmission from UE towards non-serving cell.
   Container: MAC CE or DCI. In one example, DCI can be PDCCH order.
   Can be a trigger for SRS transmission.
   Can be a PDCCH order
   Can be a PDCCH order followed by SRS transmission from UE.
Step 5: UE transmits UL transmission.
   UL transmission can be aperiodic (one shot or N shots), or UL transmission can be semi-persistent (can be deactivated at a future time by the network or by the UE).

In one embodiment, a Network triggers UE to transmit UL transmission for channel sounding/beam identification towards one or more candidate cells when a condition is satisfied.
Step 0:
   Network configures resources a UE can use for UL transmission towards neighbor cell. These are resources that can be triggered or activated by the network when needed.
   Network determines when to trigger UL transmission to neighbor cell. In one example, condition can be based on network implementation.
Step 1: Network triggers UL transmission from UE towards candidate cell.
   Container: MAC CE or DCI. In one example, DCI can be PDCCH order.
   Can be a trigger for SRS transmission.
   Can be a PDCCH order.
   Can be a PDCCH order followed by SRS transmission.
Step 2: UE transmits UL transmission.
   UL transmission can be aperiodic (one shot or N shots), or UL transmission can be semi-persistent (can be deactivated at a future time by the network or by the UE).

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, both frequency division duplexing (FDD) and time division duplexing (TDD) are evaluated as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure evaluates several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., uplink control information (UCI) on PUCCH or PUSCH). L1 control signaling be UE-specific e.g., to one UE or can be UE common (e.g., to a group of UEs or all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L (i), where i can take N values, and L (i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE (e.g., the UE 116) receives and decodes first information provided by a first signal from the network (or gNB) and based on the first information, the UE determines a starting point a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (e.g., the network 130) (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as (non-zero power NZP) CSI-RS and/or SSB) with the result of the measurement used for calculating a beam report (e.g., including at least one layer 1 reference signal received power (L1-RSRP)/layer 1 signal-to-interference-plus-noise ratio (L1-SINR) accompanied by at least one CSI-RS resource indicator (CRI) or SSB resource indicator (SSBRI)). As the network (NW)/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

FIG. 10 illustrates a flowchart of an example procedure 1000 for UL resource transmission according to embodiments of the present disclosure. For example, procedure 1000 can be performed by the UE 115 and the gNB 102 and/or network 130 in the wireless network 100 of FIG. 1. This example is for illustration only and other embodiments can be used without departing from the scope of the present disclosure.

The procedure begins in 1010, a network configures resources for UL transmissions towards candidate cell(s) and configures condition(s) to trigger transmission on resources. In 1020, a UE evaluates condition. In 1030, when condition is satisfied, the UE transmits on resources. The network can evaluate and compare the UL channel condition to the source cell and the candidate cell(s) based on the resource(s) transmitted by the UE. The network can, based on the evaluation and comparison, make a decision whether or not to perform a handover or cell switch from the serving cell to a candidate cell.

In a first embodiment a UE initiates or triggers an UL transmission towards one or more candidate cells when one or more conditions are satisfied. With reference to FIG. 10 an example of a procedure for the first embodiment is shown.

In a first step of FIG. 10, the network configures UL resource for transmission towards one or more candidate or neighbor cells.

In one example, the configured resources are for sounding reference (SRS) signal. In one example, a SRS is associated with a candidate cell. In one example, a SRS is associated with a candidate cell and a signal (e.g., SS/PBCH block or CSI-RS) associated with the candidate cell. The configuration of a SRS can include one or more of the following parameters:
Time domain resources. This can include one or more of the following parameters:
   Periodicity of SRS. The periodicity can be in units of time, e.g., symbols or slots or sub-frames of frames.
   Offset of SRS within the periodicity. The offset can be in units of time, e.g., symbols or slots or sub-frames or frames. In one example, the periodicity can be such that the start of each period (e.g., with offset 0) is aligned with the start of slot 0 of the frame with system frame number (SFN) equal to 0.
   Number of time units, e.g., symbols for SRS transmission within a slot or subframe or frame.
   Location of time units, e.g., symbols for SRS transmission within a slot or a subframe or frame. In one example, the location can be an offset of the first or last SRS symbol relative to the start or end of a slot or subframe or frame.
Frequency domain resources. This can include one or more of the following parameters:
   The start of the SRS transmission in frequency domain. In one example, this can be the first sub-carrier of SRS. In one example, this can be the first PRB of SRS. In one example, the start is offset in sub-carriers or in PRBs relative to the start or the center or the end of a bandwidth part (BWP). In one example, the start is offset in sub-carriers or in PRBs relative to the start or the center or the end of a carrier.
   The end of the SRS transmission in frequency domain. In one example, this can be the last sub-carrier of SRS. In one example, this can be the last PRB of SRS. In one example, the end is offset in sub-carriers or in PRBs relative to the start or the center or the end of a BWP. In one example, the end is offset in sub-carriers or in PRBs relative to the start or the center or the end of a carrier.
   The size (e.g., frequency span) of the SRS transmission in frequency domain. In one example, this is given in number of PRBs. In one example, this is given in number of sub-carriers.
   The comb-size. In one example, the SRS is transmitted using a comb structure, where every Nth sub-carrier (or every Nth PRB) is transmitted, this can correspond to comb size N (or comb-N). In one example, N can be one of {1, 2, 3, 4, 6, 8 or 12}.
   The comb-offset. In one example, for a comb-N, the comb offset can be an integer from 0 to N−1. In one example, a symbol dependent offset can be added to the comb to get a symbol dependent comb offset.
Code domain resources. In one example, this can include a sequence index for the SRS sequence.
TCI state or spatial relation information. In one example, a SRS resource can be linked through a spatial relation or TCI state to an SS/PBCH block or CSI-RS of a candidate cell. In one example, an SRS resource is configured for each (or for each of a subset) of SS/PBCH blocks or CSI-RS resources of a candidate cell. In one example, an SRS resource is configured for each (or for a subset) of SS/PBCH blocks or CSI-RS resources for a candidate cell, it can be up to the UE decide on the spatial relation and select one SS/PBCH blocks or CSI-RS (from each or from a subset of SS/PBCH blocks or CSI-RS resources respectively) for the spatial domain transmission filter of the SRS.

In one example, a list of SRS resources S(i), with i=0, . . . , N−1, is configured, for N candidate cells. Wherein, SRS resource S(i) is for candidate cell i.

In one example, a list of SRS resources S(i, j), with i=0, . . . , N−1, and j=0, . . . , M(i−1)−1 is configured for each of N candidate cells and M(i) signals (e.g., SS/PBCH blocks or CSI-RS resources) for candidate cell i. Wherein, SRS resource S(i, j) is for candidate cell i and signal j, and the signal is used by UE when measuring a metric and evaluating the metric as described later in this disclosure. In one example, a same value M(i) is used across candidate cells, i.e., M(i)=M for i=0, . . . , N−1. In one example, M(i) can change across the candidate cells.

In one example, the configured resources are for physical random access channel (PRACH). In one example, a PRACH is associated with a candidate cell. In one example, a PRACH is associated with a candidate cell and a signal (e.g., SS/PBCH block or CSI-RS) associated with the candidate cell. The configuration of a PRACH can include one or more of the following parameters:
Time domain resources. This can include one or more of the following parameters:
   Periodicity of PRACH. The periodicity can be in units of time, e.g., symbols or slots or sub-frames of frames.
   Offset of PRACH within the periodicity. The offset can be in units of time, e.g., symbols or slots or sub-frames or frames. In one example, the periodicity can be such that the start of each period (e.g., with offset 0) is aligned with the start of slot 0 of the frame with system frame number (SFN) equal to 0.
   Number of time units, e.g., symbols for PRACH transmission within a slot or subframe or frame.
   PRACH preamble format. In one example, the PRACH preamble format can indicate the number of time units, e.g., symbols or slots used for PRACH.
   Location of time units, e.g., symbols or PRACH occasions (ROs) for PRACH transmission within a slot or a subframe or frame. In one example, the location can be an offset of the first or last SRS symbol relative to the start or end of a slot or subframe or frame.
Frequency domain resources. This can include one or more of the following parameters:
   The start of the PRACH transmission in frequency domain. In one example, this can be the first sub-carrier of PRACH. In one example, this can be the first PRB of PRACH. In one example, the start is offset in sub-carriers or in PRBs relative to the start or the center or the end of a BWP. In one example, the start is offset in sub-carriers or in PRBs relative to the start or the center or the end of a carrier.
   The end of the PRACH transmission in frequency domain. In one example, this can be the last sub-carrier of PRACH. In one example, this can be the last PRB of PRACH. In one example, the end is offset in sub-carriers or in PRBs relative to the start or the center or the end of a BWP. In one example, the end is offset in sub-carriers or in PRBs relative to the start or the center or the end of a carrier.
   The PRACH Occasion in frequency domain.
   The size (e.g., frequency span) of the PRACH transmission in frequency domain. In one example, this is given in number of PRBs. In one example, this is given in number of sub-carriers. In one example, this is determined based on the preamble format. In one example, this is determined based on the sub-carrier spacing of PRACH. In one example, this is determined based on the sub-carrier spacing of the UL BWP.
Code domain resources. This can include one or more of the following:
   In one example, this can include a root sequence index to use for PRACH.
   In one example, this can include a cyclic shift sequence index in a root sequence to use for PRACH.
   In one example, this can include the PRACH or preamble sequence index.
TCI state or spatial relation information.
   In one example, a PRACH resource can be linked through a spatial relation or TCI state to an SS/PBCH block or CSI-RS of a candidate cell. In one example, a PRACH resource is configured for each (or for each of a subset) of SS/PBCH blocks or CSI-RS resources of a candidate cell. In one example, a PRACH resource is configured for each (or for a subset) of SS/PBCH blocks or CSI-RS resources for a candidate cell, it can be up to the UE decide on the spatial relation and select one SS/PBCH blocks or CSI-RS resources (from each or from a subset of SS/PBCH blocks or CSI-RS resources respectively) for the spatial domain transmission filter of the PRACH.
   In one example, an association pattern is configured for PRACH of a candidate cell. The association pattern is between PRACH preambles and ROs and SS/PBCH blocks or CSI-RS resources of candidate cells. A UE selects a preamble within an RO based on the associated SS/PBCH block or CSI-RS.

In one example, a list of PRACH resources S(i), with i=0, . . . , N−1, is configured, for N candidate cells. Wherein, PRACH resource S(i) is for candidate cell i.

In one example, a list of PRACH resources S(i, j), with i=0, . . . , N−1, and j=0, . . . , M(i−1)−1 is configured for each of N candidate cells and M(i) signals (e.g., SS/PBCH blocks or CSI-RS resources) for candidate cell i. Wherein, PRACH resource S(i, j) is for candidate cell i and signal j, and the signal is used by UE when measuring a metric and evaluating the metric as described later in this disclosure. In one example, a same value M(i) is used across candidate cells, i.e., M(i)=M for i=0, . . . , N−1. In one example, M(i) can change across the candidate cells.

In one example, a PRACH configuration is provided for N candidate cells. The PRACH configuration includes the preamble configuration (e.g., format and sequence), the PRACH Occasions configuration (e.g., in time and frequency) and the association of PRACH occasions and preambles to SS/PBCH blocks of the corresponding candidate cell.

In the first step of FIG. 10, the network can configure a pre-notification to be transmitted before the UL resources. In one example, a pre-notification resource is associated with a candidate cell. In one example, a pre-notification resource is associated with a candidate cell and a signal (e.g., SS/PBCH block or CSI-RS) associated with the candidate cell.

In one example, the pre-notification is transmitted on a PUCCH. In one example, the pre-notification is transmitted on a sequence based short PUCCH format (e.g., PUCCH format 0 in NR). In one example, the pre-notification is transmitted on a sequence based long PUCCH format (e.g., PUCCH format 1 in NR). The configuration of the PUCCH for the pre-notification can include one or more of the following parameters:
Time domain resources. This can include one or more of the following parameters:
   Periodicity of PUCCH. The periodicity can be in units of time, e.g., symbols or slots or sub-frames of frames.
   Offset of PUCCH within the periodicity. The offset can be in units of time, e.g., symbols or slots or sub-frames or frames. In one example, the periodicity can be such that the start of each period (e.g., with offset 0) is aligned with the start of slot 0 of the frame with system frame number (SFN) equal to 0.
   Number of time units, e.g., symbols for PUCCH transmission within a slot or subframe or frame. In one example, the number for PUCCH is determined by the PUCCH format.
   Location of time units, e.g., symbols for PUCCH transmission within a slot or a subframe or frame. In one example, the location can be an offset of the first or last PUCCH symbol relative to the start or end of a slot or subframe or frame.
Frequency domain resources. This can include one or more of the following parameters:
   The start of the PUCCH transmission in frequency domain. In one example, this can be the first sub-carrier of PUCCH. In one example, this can be the first PRB of PUCCH. In one example, the start is offset in sub-carriers or in PRBs relative to the start or the center or the end of a BWP. In one example, the start is offset in sub-carriers or in PRBs relative to the start or the center or the end of a carrier.
   The end of the PUCCH transmission in frequency domain. In one example, this can be the last sub-carrier of PUCCH. In one example, this can be the last PRB of PUCCH. In one example, the end is offset in sub-carriers or in PRBs relative to the start or the center or the end of a BWP. In one example, the end is offset in sub-carriers or in PRBs relative to the start or the center or the end of a carrier.
   The size (e.g., frequency span) of the PUCCH transmission in frequency domain. In one example, this is given in number of PRBs. In one example, this is given in number of sub-carriers. In one example, the size is determined by PUCCH format.
Code domain resources. In one example, this can include a sequence index for the PUCCH sequence. In one example, this can include the cycle shift for the PUCCH resource.
TCI state or spatial relation information. In one example, a PUCCH resource can be linked through a spatial relation or TCI state to an SS/PBCH block or CSI-RS of a candidate cell. In one example, a PUCCH resource is configured for each (or for each of a subset) of SS/PBCH blocks or CSI-RS resources of a candidate cell. In one example, a PUCCH resource is configured for each (or for a subset) of SS/PBCH blocks or CSI-RS resources for a candidate cell, it can be up to the UE to decide on the spatial relation and select one SS/PBCH blocks or CSI-RS (from each or from a subset of SS/PBCH blocks or CSI-RS resources respectively) for the spatial domain transmission filter of the PUCCH. In one example, the PUCCH resource with scheduling request or pre-notification is sent towards the serving cell, and uses a spatial relation or TCI state of the serving cell (e.g., the indicated or unified UL or Joint TCI state).

In one example, a list of PUCCH resources S(i), with i=0, . . . , N−1, is configured, for N candidate cells. Wherein, PUCCH resource S(i) is for candidate cell i.

In one example, a list of PUCCH resources S(i, j), with i=0, . . . , N−1, and j=0, . . . , M(i−1)−1 is configured for each of N candidate cells and M(i) signals (e.g., SS/PBCH blocks or CSI-RS resources) for candidate cell i. Wherein, PUCCH resource S(i, j) is for candidate cell i and signal j, and the signal is used by UE when measuring a metric and evaluating the metric as described later in this disclosure. In one example, a same value M(i) is used across candidate cells, i.e., M(i)=M for i=0, . . . , N−1. In one example, M(i) can change across the candidate cells.

In one example, an association is configured between the pre-notification resources and the UL transmission resources (e.g., SRS). In on example, a time gap is configured between the pre-notification resources and the UL transmission resources (e.g., SRS). In one example, the pre-notification resource and the associated UL transmission resource are transmitted to a same cell (e.g., a same candidate cell). In one example, the pre-notification resource is transmitted to a first cell and the associated UL transmission resource is transmitted to a second cell (e.g., a first cell is a serving cell, and second cell is a candidate cell).

In the first step of FIG. 10, the network configures one or more conditions for transmission on UL resources towards a candidate cell.

In one example, a condition can be based on RSRP of a signal from a candidate cell. In one example, a condition can be based on RSRQ of a signal from a candidate cell. In one example, a condition can be based on RSRP of a signal from a candidate cell. The RSRP or RSRQ or SINR are referred as a metric.

In one example, the signal used to measure the metric is SS/PBCH Block of a candidate cell. In one example, the network configures with the UE with one or more SS/PBCH blocks of one or more candidate cells for metric measurement.

In one example, the signal used to measure the metric is CSI-RS of a candidate cell. In one example, the network configures with the UE with one or more CSI-RS resources of one or more candidate cells for metric measurement.

In one example, the signals to measure a metric for a candidate cell can be configured by higher layer signaling (e.g., SIB-based signaling (for example SIB1) or RRC signaling). The signals to measure a metric for a candidate cell can be updated or activated by dynamic signaling (e.g., MAC CE signaling or L1 control signaling). In one example, the signals to measure for transmission of UL signal to a candidate cell, are the same as the signals the UE measures for a measurement report (e.g., measurement report for mobility or handover or beam management). In one example, the signals to measure for transmission of UL signal to a candidate cell, are a subset of the signals the UE measures for a measurement report (e.g., measurement report for mobility or handover or beam management). In one example, the candidate cells for UL transmission are the same as the cells measured for a measurement report (e.g., measurement report for mobility or handover or beam management). In one example, the candidate cells for UL transmission are a subset of the cells measured for a measurement report (e.g., measurement report for mobility or handover or beam management).

In one example, the condition is based on a threshold X. In one example, the network configures the UE (e.g., the UE 116) with a threshold X, wherein the threshold X is common for candidate cells and signals used for measurement within the candidate cells. In one example, the network configures the UE with a threshold X (Y) for candidate cell Y for SS/PBCH blocks, for example, Y=0, . . . , N−1, where N is the number of candidate cells. In one example, the network configures the UE with a threshold X (Y) for candidate cell Y for CSI-RS resources, for example, Y=0, . . . , N−1, where N is the number of candidate cells. In one example, the network configures the UE with a threshold X (Y, Z) for candidate cell Y for SS/PBCH block Z of candidate cell Y, for example, Y=0, . . . , N−1, where N is the number of candidate cells, and Z=0, . . . , M−1, where M is the number of SS/PBCH blocks for candidate cell Y. In one example, the network (e.g., the network 130) configures the UE with a threshold X (Y, Z) for candidate cell Y for CSI-RS resource Z of candidate cell Y, for example, Y=0, . . . , N−1, where N is the number of candidate cells, and Z=0, . . . , M−1, where M is the number of CSI-RS resources for candidate cell Y.

In one example, the threshold, e.g., X or X (Y) or X (Y,Z) can be configured by higher layer signaling (e.g., SIB-based signaling (for example SIB1) or RRC signaling). In one example, the threshold, e.g., X or X (Y) or X (Y,Z) can be updated by dynamic signaling (e.g., MAC CE signaling or L1 control signaling).

In one example, multiple values of the threshold X or X (Y) or X (Y,Z) are configured based on a parameter(s) U. i.e., the threshold configured can be
X (U), where X is a function of U.
X (Y,U), where X is a function of Y (candidate cell) and U.
X (Y,Z,U), where X is a function of Y (candidate cell), Z (signal of candidate cell) and U.

In one example, U can be based on one or more of:
UE power category, e.g., PC2 or PC3
Number of Rx antennas per UE, e.g., 2 or 4 or 6 or 8.
Number of Tx antennas per UE, e.g., 2 or 4 or 6 or 8.
Pair of number of Tx antennas and number of Rx antennas.

In a second step of FIG. 10, the UE evaluates the condition.

In one example, the condition can be a metric of a candidate cell is greater than a threshold.

In one example, the condition can be the metric of a candidate cell is greater than or equal to a threshold.

In one example, the condition can be the ratio of the metric of a candidate cell and corresponding metric of the serving is greater than a threshold. Wherein the network configures the UE to measure the metric on the serving (e.g., on a signal, e.g., SS/PBCH or CSI-RS of the serving cell), in one example, the signal, e.g., SS/PBCH or CSI-RS of the serving cell, can be associated with the main or indicated or unified TCI state.

In one example, the condition can be the ratio of the metric of a candidate cell and corresponding metric of the serving is greater than or equal to a threshold. Wherein the network configures the UE to measure the metric on the serving (e.g., on a signal, e.g., SS/PBCH or CSI-RS of the serving cell), in one example, the signal, e.g., SS/PBCH or CSI-RS of the serving cell, can be associated with the main or indicated or unified TCI state.

In one example, the condition can be the difference of the metric of a candidate cell and corresponding metric of the serving is greater than a threshold. In one example, the threshold is in dB. Wherein the network configures the UE to measure the metric on the serving (e.g., on a signal, e.g., SS/PBCH or CSI-RS of the serving cell), in one example, the signal, e.g., SS/PBCH or CSI-RS of the serving cell, can be associated with the main or indicated or unified TCI state.

In one example, the condition can be the difference of the metric of a candidate cell and corresponding metric of the serving is greater than or equal to a threshold. In one example, the threshold is in dB. Wherein the network configures the UE to measure the metric on the serving (e.g., on a signal, e.g., SS/PBCH or CSI-RS of the serving cell), in one example, the signal, e.g., SS/PBCH or CSI-RS of the serving cell, can be associated with the main or indicated or unified TCI state. In the aforementioned examples, the association can be through a QCL relation (e.g., Type-D) or a spatial relation.

In one example, two thresholds are configured, a first threshold and a second threshold. Wherein, the condition is to satisfy both condition A and condition B.

In one example, condition A can be a metric of a candidate cell is greater than the first threshold.

In one example, condition A can be the metric of a candidate cell is greater than or equal to the first threshold.

In one example, condition B can be the ratio of the metric of a candidate cell and corresponding metric of the serving is greater than the second threshold.

In one example, condition B can be the ratio of the metric of a candidate cell and corresponding metric of the serving is greater than or equal to the second threshold.

In one example, condition B can be the difference of the metric of a candidate cell and corresponding metric of the serving is greater than the second threshold. In one example, the threshold is in dB.

In one example, condition B can be the difference of the metric of a candidate cell and corresponding metric of the serving is greater than or equal to the second threshold. In one example, the threshold is in dB.

In one example, condition B can be the metric of the serving cell is less than the second threshold.

In one example, condition B can be the metric of the serving cell is less or equal to the second threshold.

In one example, two thresholds are configured, a first threshold and a second threshold. Wherein, the condition is to satisfy at least one of condition A and condition B:

In one example, condition A can be a metric of a candidate cell is greater than the first threshold.

In one example, condition A can be the metric of a candidate cell is greater than or equal to the first threshold.

In one example, condition B can be the ratio of the metric of a candidate cell and corresponding metric of the serving is greater than the second threshold.

In one example, condition B can be the ratio of the metric of a candidate cell and corresponding metric of the serving is greater than or equal to the second threshold.

In one example, condition B can be the difference of the metric of a candidate cell and corresponding metric of the serving is greater than the second threshold. In one example, the threshold is dB.

In one example, condition B can be the difference of the metric of a candidate cell and corresponding metric of the serving is greater than or equal to the second threshold. In one example, the threshold is dB.

In one example, condition B can be the metric of the serving cell is less than the second threshold.

In one example, condition B can be the metric of the serving cell is less or equal to the second threshold.

In a variant of the examples described herein, “greater than” or “less than” can be replaced by “less than” or “greater than” respectively.

In the examples described herein, the metric of the serving can be one of:
In one example, the metric measured using a SS/PBCH block of the serving cell corresponding (e.g., through quasi-co-location) to an indicated or unified DL TCI state.
In one example, the metric measured using a SS/PBCH block of the serving cell corresponding (e.g., through quasi-co-location) to an indicated or unified UL TCI state.
In one example, the metric measured using a SS/PBCH block of the serving cell corresponding (e.g., through quasi-co-location) to an indicated or unified joint TCI state.
In one example, the metric measured using a SS/PBCH block of the serving cell corresponding to the SS/PBCH block with the largest metric.
In one example, the metric measured using a CSI-RS resource of the serving cell corresponding (e.g., through quasi-co-location) to an indicated or unified DL TCI state.
In one example, the metric measured using a CSI-RS resource of the serving cell corresponding (e.g., through quasi-co-location) to an indicated or unified UL TCI state.
In one example, the metric measured using a CSI-RS resource of the serving cell corresponding (e.g., through quasi-co-location) to an indicated or unified joint TCI state.
In one example, the metric measured using a CSI-RS resource of the serving cell corresponding to the CSI-RS resource with the largest metric.

In the examples described herein, the metric of a candidate cell can be evaluated over the configured or updated or activated signals (e.g., SS/PBCH blocks and CSI-RS resources) of the candidate cell. In one example, the signals to measure for transmission of UL signal to a candidate cell, are the same as the signals the UE measures for a measurement report (e.g., measurement report for mobility or handover or beam management). In one example, the signals to measure for transmission of UL signal to a candidate cell, are a subset of the signals the UE measures for a measurement report (e.g., measurement report for mobility or handover or beam management).

In the examples described herein, the metric can be evaluated over the configured or updated or activated candidate cells. In one example, the candidate cells for UL transmission are the same as the cells measured for a measurement report (e.g., measurement report for mobility or handover or beam management). In one example, the candidate cells for UL transmission are a subset of the cells measured for a measurement report (e.g., measurement report for mobility or handover or beam management). In one example, the candidate cells or the candidate cells and associated signals the UE evaluates for transmitting the associated UL resource(s) can be indicated by L1 control (e.g., DCI signaling) and/or can be activated by MAC CE signaling.

In a third step of FIG. 10, when a condition is satisfied the UE transmits on a corresponding UL resource. In one example, the UE transmits one or more UL resources to one or more respective cells.

In one example, when a condition is satisfied corresponding to candidate cell Y, the UE transmits on the UL resource corresponding to candidate cell Y.

In one example, when a condition is satisfied corresponding to candidate cell Y and signal (e.g., SS/PBCH block or CSI-RS resource) Z of candidate cell Y, the UE transmits on the UL resource corresponding to candidate cell Y and signal Z.

In one example, when a condition is satisfied corresponding to candidate cell Y and signal (e.g., SS/PBCH block or CSI-RS resource) Z of candidate cell Y, the UE transmits on the UL resource corresponding to candidate cell Y using a TCI state or a spatial relation or spatial domain filter corresponding to signal Z.

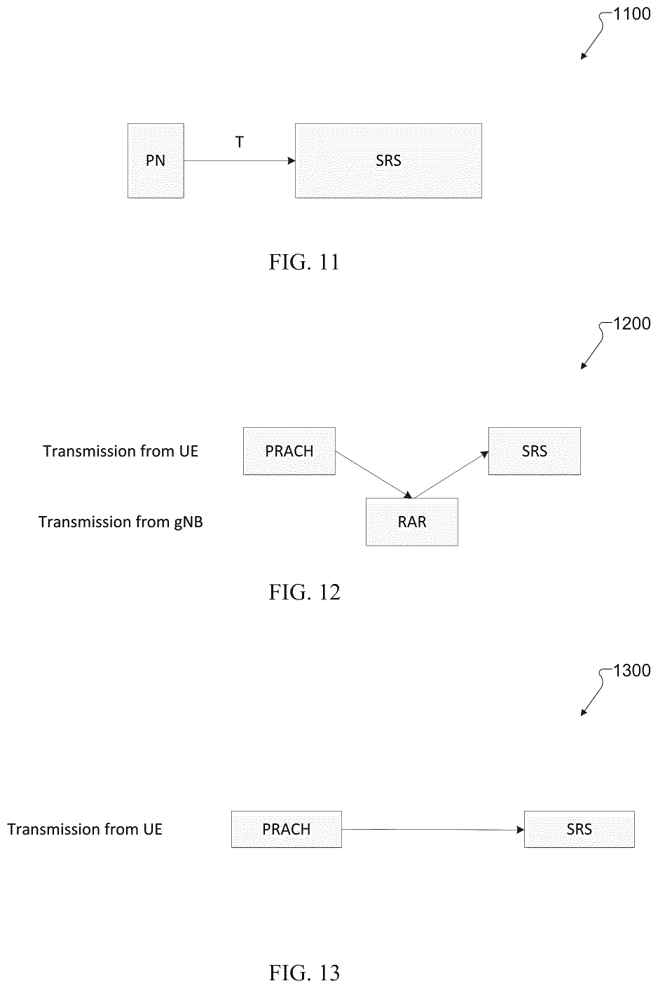

FIG. 11 illustrates a diagram of an example UL transmission 1100 according to embodiments of the present disclosure. For example, UL transmission 1100 can be transmitted by any of the UEs 111-116 of FIG. 1. This example is for illustration only and other embodiments can be used without departing from the scope of the present disclosure.

In one example, the UL transmission is an SRS transmission.

In one example, the UL transmission is an SRS transmission. The SRS transmission is preceded by a pre-notification signal. The pre-notification is configured as aforementioned. With reference to FIG. 11, an example between a pre-notification (PN) signal for followed by an UL transmission (e.g., SRS) is shown. In one example, PN is transmitted towards candidate cell e.g., using a spatial filter associated with candidate cell. In one example, PN is transmitted towards serving cell, e.g., using a spatial filter associated with serving cell. In one example, the time between the PN and the SRS is T. In one example, Tis the time between the start of the PN and the start of the SRS. In one example, T is the time between the end of the PN and the start of the SRS. In one example, T is the time between the start of the PN and the end of the SRS. In one example, T is the time between the end of the PN and the end of the SRS. In one example, T is the time between the start of the PN and the slot (e.g., start or end) of the SRS. In one example, T is the time between the end of the PN and the slot (e.g., start or end) of the SRS. In one example, Tis the time between the slot (e.g., start or end) of the PN and the slot (e.g., start or end) of the SRS. In one example, T is the time between the slot (e.g., start or end) of the PN and the start or end of the SRS.

FIG. 12 illustrates a diagram of an example UL and DL transmission 1200 according to embodiments of the present disclosure. For example, UL and DL transmission 1200 can be transmitted by any of the UEs 111-116 and BS 103 of FIG. 1, respectively. This example is for illustration only and other embodiments can be used without departing from the scope of the present disclosure.

In one example, the UL transmission is a PRACH transmission.

In one example, the UL transmission is a PRACH transmission is followed by a SRS transmission.

In one example with reference to FIG. 12, the PRACH transmission and SRS transmission follow a Type-1 like random access procedure, wherein the network receives the PRACH and sends a random access response. In one example, the random access response includes a grant for the SRS transmission, including the resources to use. In one example, the random access response includes a TA command for the SRS transmission. In one example, RAR can be transmitted from serving cells. In one example, RAR can be transmitted from candidate cell. In one example, PRACH is transmitted towards candidate cell e.g., using a spatial filter associated with candidate cell. In one example, PRACH is transmitted towards serving cell, e.g., using a spatial filter associated with serving cell.

FIG. 13 illustrates a diagram of an example UL transmission 1300 according to embodiments of the present disclosure. For example, UL transmission 1300 can be transmitted by the UE 116 of FIG. 3. This example is for illustration only and other embodiments can be used without departing from the scope of the present disclosure.

In one example with reference to FIG. 13, the PRACH transmission and SRS transmission follow a Type-2 like random access procedure, wherein the UL transmission includes a PRACH transmission followed by a SRS transmission. In one example, PRACH is transmitted towards candidate cell e.g., using a spatial filter associated with candidate cell. In one example, PRACH is transmitted towards serving cell, e.g., using a spatial filter associated with serving cell.

In one example, the cells are in a same TAG, and the UE can use the TA of the serving cell for a transmission associated with a candidate cell.

In one example, the UE estimates the transmission time based on the difference between the arrival time of a signal from a candidate cell and the arrival time of a signal from the serving cell. In one example, this can be as described in U.S. patent application Ser. No. 18/603,085 filed on Mar. 12, 2024 (the '085 application), which is incorporated by reference in its entirety.

In one example, the UL transmission is transmitted once.

In one example, the UL transmission is repeated K times (or repeated within a time interval I) with a period T, wherein K and/or I and/or T can be configured and/or updated by RRC signaling and/or MAC CE signaling and/or L1 control signaling.

In one example, the UL transmission is repeated with a period T until deactivated, wherein T can be configured and/or updated by RRC signaling and/or MAC CE signaling and/or L1 control signaling. In one example, the deactivation can be by RRC signaling or MAC CE signaling or L1 control signaling. In one example, the deactivation signal is from the serving cell. In one example, the deactivation signal is from the candidate cell.

In one example, the UE transmits the UL signal associated with a candidate cell in a measurement gap (MG) or as part of a MG, e.g., to minimize disruption of communication after the MG. In one example, the UE signal is transmitted towards the end of the MG.

In one example, the UE transmits UL signal associated with M or up to M candidate cells (or candidate cell-signal pairs). For example, M candidate cells (or candidate cell-signal pairs) with the largest metrics, and/or up to M candidate cells (or candidate cell-signal pairs) with the largest metrics and the metric exceeds a threshold as aforementioned. As aforementioned, the metric can be RSRP or SINR or RSRQ. In one example, M can be defined in the system specifications and/or configured or updated by RRC signaling and/or MAC CE signaling and/or L1 control signaling.

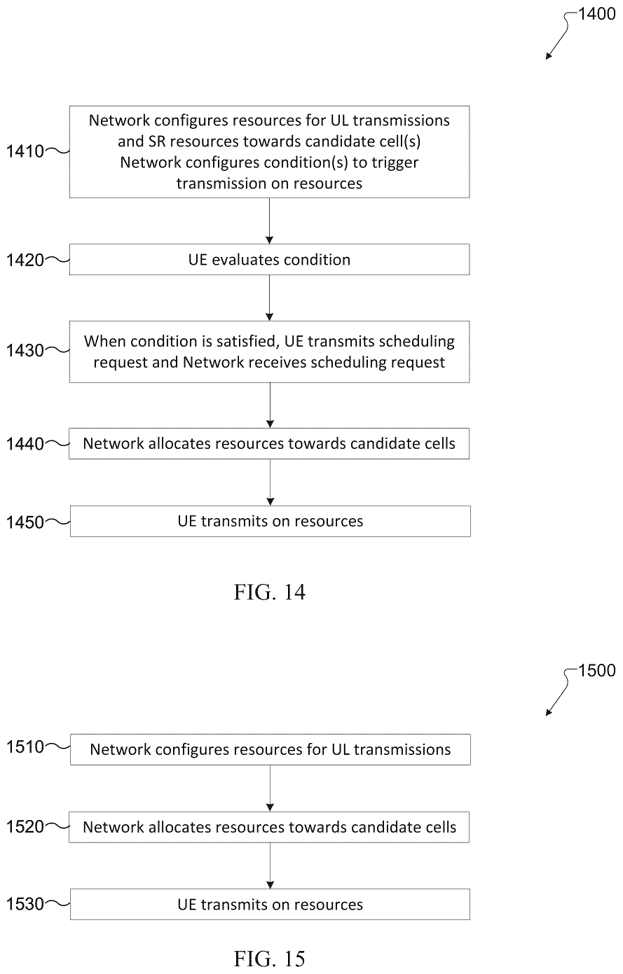

FIG. 14 illustrates a flowchart of an example procedure 1400 for UL resource transmission according to embodiments of the present disclosure. For example, procedure 1400 for UL resource transmission can be performed by the UE 116 and the gNB 102 and/or network 130 in the wireless network 100 of FIG. 1. This example is for illustration only and other embodiments can be used without departing from the scope of the present disclosure.

The procedure begins in 1410, a network configures resources for UL transmissions and SR resources towards candidate cell(s) and configures condition(s) to trigger transmission on resources. In 1420, a UE evaluates the condition. In 1430, when the condition is satisfied, the UE transmits scheduling request, and the network receives the scheduling request. In 1440, the network allocates resources towards candidate cells. In 1450, the UE transmits on resources. The network can evaluate and compare the UL channel condition to the source cell and the candidate cell(s) based on the resource(s) transmitted by the UE. The network can, based on the evaluation and comparison, make a decision whether or not to perform a handover or cell switch from the serving cell to a candidate cell.

In a second embodiment a UE initiates or triggers a scheduling request for an UL transmission towards one or more candidate cells when one or more conditions are satisfied. With reference to FIG. 14 an example of a procedure for the second embodiment is shown.

In a first step of FIG. 14, the network can configure UL resource for transmission towards one or more candidate or neighbor cells.

In one example, the configured resources are for sounding reference (SRS) signal. In one example, a SRS is associated with a candidate cell. In one example, a SRS is associated with a candidate cell and a signal (e.g., SS/PBCH block or CSI-RS) associated with the candidate cell. The configuration of the SRS can include one or more of the following parameters:
Time domain resources. This can include one or more of the following parameters:
   Periodicity of SRS. The periodicity can be in units of time, e.g., symbols or slots or sub-frames of frames.
   Offset of SRS within the periodicity. The offset can be in units of time, e.g., symbols or slots or sub-frames or frames. In one example, the periodicity can be such that the start of each period (e.g., with offset 0) is aligned with the start of slot 0 of the frame with system frame number (SFN) equal to 0.
   Number of time units, e.g., symbols for SRS transmission within a slot or subframe or frame.
   Location of time units, e.g., symbols for SRS transmission within a slot or a subframe or frame. In one example, the location can be an offset of the first or last SRS symbol relative to the start or end of a slot or subframe or frame.
Frequency domain resources. This can include one or more of the following parameters:
   The start of the SRS transmission in frequency domain. In one example, this can be the first sub-carrier of SRS. In one example, this can be the first PRB of SRS. In one example, the start is offset in sub-carriers or in PRBs relative to the start or the center or the end of a BWP. In one example, the start is offset in sub-carriers or in PRBs relative to the start or the center or the end of a carrier.
   The end of the SRS transmission in frequency domain. In one example, this can be the last sub-carrier of SRS. In one example, this can be the last PRB of SRS. In one example, the end is offset in sub-carriers or in PRBs relative to the start or the center or the end of a BWP. In one example, the end is offset in sub-carriers or in PRBs relative to the start or the center or the end of a carrier.
   The size (e.g., frequency span) of the SRS transmission in frequency domain. In one example, this is given in number of PRBs. In one example, this is given in number of sub-carriers.
   The comb-size. In one example, the SRS is transmitted using a comb structure, where every Nth sub-carrier (or every Nth PRB) is transmitted, this can correspond to comb size N (or comb-N). In one example, N can be one of {1, 2, 3, 4, 6, 8 or 12}.
   The comb-offset. In one example, for a comb-N, the comb offset can be an integer from 0 to N−1. In one example, a symbol dependent offset can be added to the comb to get a symbol dependent comb offset.
Code domain resources. In one example, this can include a sequence index for the SRS sequence.
TCI state or spatial relation information. In one example, a SRS resource can be linked through a spatial relation or TCI state to an SS/PBCH block or CSI-RS of a candidate cell. In one example, an SRS resource is configured for each (or for each of a subset) of SS/PBCH blocks or CSI-RS resources of a candidate cell. In one example, an SRS resource is configured for each (or for a subset) of SS/PBCH blocks or CSI-RS resources for a candidate cell, it can be up to the UE to decide on the spatial relation and select one SS/PBCH blocks or CSI-RS (from each or from a subset of SS/PBCH blocks or CSI-RS resources respectively) for the spatial domain transmission filter of the SRS.

In one example, a list of SRS resources S(i), with i=0, . . . , N−1, is configured, for N candidate cells. Wherein, SRS resource S(i) is for candidate cell i.

In one example, a list of SRS resources S(i, j), with i=0, . . . , N−1, and j=0, . . . , M(i−1)−1 is configured for each of N candidate cells and M(i) signals (e.g., SS/PBCH blocks or CSI-RS resources) for candidate cell i. Wherein, SRS resource S(i, j) is for candidate cell i and signal j, and the signal is used by UE when measuring a metric and evaluating the metric as described later in this disclosure. In one example, a same value M(i) is used across candidate cells, i.e., M(i)=M for i=0, . . . , N−1. In one example, M(i) can change across the candidate cells.

In one example, the configured resources are for physical random access channel (PRACH). In one example, a PRACH is associated with a candidate cell. In one example, a PRACH is associated with a candidate cell and a signal (e.g., SS/PBCH block or CSI-RS) associated with the candidate cell. The configuration of the PRACH can include one or more of the following parameters:
Time domain resources. This can include one or more of the following parameters:
   Periodicity of PRACH. The periodicity can be in units of time, e.g., symbols or slots or sub-frames of frames.
   Offset of PRACH within the periodicity. The offset can be in units of time, e.g., symbols or slots or sub-frames or frames. In one example, the periodicity can be such that the start of each period (e.g., with offset 0) is aligned with the start of slot 0 of the frame with system frame number (SFN) equal to 0.
   Number of time units, e.g., symbols for PRACH transmission within a slot or subframe or frame.
   PRACH preamble format. In one example, the PRACH preamble format can indicate the number of symbols or slots used for PRACH.
   Location of time units, e.g., symbols or PRACH occasions (ROs) for PRACH transmission within a slot or a subframe or frame. In one example, the location can be an offset of the first or last PRACH symbol relative to the start or end of a slot or subframe or frame.
Frequency domain resources. This can include one or more of the following parameters:
   The start of the PRACH transmission in frequency domain. In one example, this can be the first sub-carrier of PRACH. In one example, this can be the first PRB of PRACH. In one example, the start is offset in sub-carriers or in PRBs relative to the start or the center or the end of a BWP. In one example, the start is offset in sub-carriers or in PRBs relative to the start or the center or the end of a carrier.
   The end of the PRACH transmission in frequency domain. In one example, this can be the last sub-carrier of PRACH. In one example, this can be the last PRB of PRACH. In one example, the end is offset in sub-carriers or in PRBs relative to the start or the center or the end of a BWP. In one example, the end is offset in sub-carriers or in PRBs relative to the start or the center or the end of a carrier.
   The PRACH Occasion in frequency domain.
   The size (e.g., frequency span) of the PRACH transmission in frequency domain. In one example, this is given in number of PRBs. In one example, this is given in number of sub-carriers. In one example, this is determined based on the preamble format. In one example, this is determined based on the sub-carrier spacing of PRACH. In one example, this is determined based on the sub-carrier spacing of the UL BWP.
Code domain resources. This can include one or more of the following:
   In one example, this can include a root sequence index to use for PRACH.
   In one example, this can include a cyclic shift sequence index in a root sequence to use for PRACH.
   In one example, this can include the PRACH or preamble sequence index.
TCI state or spatial relation information.
   In one example, a PRACH resource can be linked through a spatial relation or TCI state to an SS/PBCH block or CSI-RS of a candidate cell. In one example, a PRACH resource is configured for each (or for each of a subset) of SS/PBCH blocks or CSI-RS resources of a candidate cell. In one example, a PRACH resource is configured for each (or for a subset) of SS/PBCH blocks or CSI-RS resources for a candidate cell, it can be up to the UE decide on the spatial relation and select one SS/PBCH blocks or CSI-RS resources (from each or from a subset of SS/PBCH blocks or CSI-RS resources respectively) for the spatial domain transmission filter of the PRACH.
   In one example, an association pattern is configured for PRACH of a candidate cell. The association pattern is between PRACH preambles and ROs and SS/PBCH blocks or CSI-RS resources of candidate cells. A UE selects a preamble within an RO based on the associated SS/PBCH block or CSI-RS.

In one example, a list of PRACH resources S(i), with i=0, . . . , N−1, is configured, for N candidate cells. Wherein, PRACH resource S(i) is for candidate cell i.

In one example, a list of PRACH resources S(i, j), with i=0, . . . , N−1, and j=0, . . . , M(i−1)−1 is configured for each of N candidate cells and M(i) signals (e.g., SS/PBCH blocks or CSI-RS resources) for candidate cell i. Wherein, PRACH resource S(i, j) is for candidate cell i and signal j, and the signal is used by UE when measuring a metric and evaluating the metric as described later in this disclosure. In one example, a same value M(i) is used across candidate cells, i.e., M(i)=M for i=0, . . . , N−1. In one example, M(i) can change across the candidate cells.

In one example, a PRACH configuration is provided for N candidate cells. The PRACH configuration includes the preamble configuration (e.g., format and sequence), the PRACH Occasions configuration (e.g., in time and frequency) and the association of PRACH occasions and preambles to SS/PBCH blocks of the corresponding candidate cell.

In the first step of FIG. 14, the network can configure UL resource for a scheduling request for UL resources. In one example, a scheduling request is associated with a candidate cell. In one example, a scheduling request is associated with a candidate cell and a signal (e.g., SS/PBCH block or CSI-RS) associated with the candidate cell. In one example, the scheduling request can be sent towards the serving cell. In one example scheduling request can be set towards a candidate cell (e.g., the candidate cell towards which the UL transmission is sent).

In one example, the scheduling request is transmitted on a PUCCH. In one example, the scheduling requested is transmitted on a sequence based short PUCCH format (e.g., PUCCH format 0 in NR). In one example, the scheduling requested is transmitted on a sequence based long PUCCH format (e.g., PUCCH format 1 in NR). The configuration of the PUCCH for the scheduling request can include one or more of the following parameters:
Time domain resources. This can include one or more of the following parameters:
   Periodicity of PUCCH. The periodicity can be in units of time, e.g., symbols or slots or sub-frames of frames.
   Offset of PUCCH within the periodicity. The offset can be in units of time, e.g., symbols or slots or sub-frames or frames. In one example, the periodicity can be such that the start of each period (e.g., with offset 0) is aligned with the start of slot 0 of the frame with system frame number (SFN) equal to 0.
   Number of time units, e.g., symbols for PUCCH transmission within a slot or subframe or frame. In one example, the number for PUCCH is determined by the PUCCH format.
   Location of time units, e.g., symbols for PUCCH transmission within a slot or a subframe or frame. In one example, the location can be an offset of the first or last PUCCH symbol relative to the start or end of a slot or subframe or frame.
Frequency domain resources. This can include one or more of the following parameters:
   The start of the PUCCH transmission in frequency domain. In one example, this can be the first sub-carrier of PUCCH. In one example, this can be the first PRB of PUCCH. In one example, the start is offset in sub-carriers or in PRBs relative to the start or the center or the end of a BWP. In one example, the start is offset in sub-carriers or in PRBs relative to the start or the center or the end of a carrier.
   The end of the PUCCH transmission in frequency domain. In one example, this can be the last sub-carrier of PUCCH. In one example, this can be the last PRB of PUCCH. In one example, the end is offset in sub-carriers or in PRBs relative to the start or the center or the end of a BWP. In one example, the end is offset in sub-carriers or in PRBs relative to the start or the center or the end of a carrier.
   The size (e.g., frequency span) of the PUCCH transmission in frequency domain. In one example, this is given in number of PRBs. In one example, this is given in number of sub-carriers. In one example, the size is determined by PUCCH format.
Code domain resources. In one example, this can include a sequence index for the PUCCH sequence. In one example, this can include the cycle shift for the PUCCH resource.
TCI state or spatial relation information. In one example, a PUCCH resource can be linked through a spatial relation or TCI state to an SS/PBCH block or CSI-RS of a candidate cell. In one example, a PUCCH resource is configured for each (or for each of a subset) of SS/PBCH blocks or CSI-RS resources of a candidate cell. In one example, a PUCCH resource is configured for each (or for a subset) of SS/PBCH blocks or CSI-RS resources for a candidate cell, it can be up to the UE to decide on the spatial relation and select one SS/PBCH blocks or CSI-RS (from each or from a subset of SS/PBCH blocks or CSI-RS resources respectively) for the spatial domain transmission filter of the PUCCH. In one example, the PUCCH resource with scheduling request is sent towards the serving cell, and uses a spatial relation or TCI state of the serving cell (e.g., the indicated or unified UL or Joint TCI state).

In one example, a list of PUCCH resources S(i), with i=0, . . . , N−1, is configured, for N candidate cells. Wherein, PUCCH resource S(i) is for candidate cell i.

In one example, a list of PUCCH resources S(i, j), with i=0, . . . , N−1, and j=0, . . . , M(i−1)−1 is configured for each of N candidate cells and M(i) signals (e.g., SS/PBCH blocks or CSI-RS resources) for candidate cell i. Wherein, PUCCH resource S(i, j) is for candidate cell i and signal j, and the signal is used by UE (e.g., the UE 116) when measuring a metric and evaluating the metric as described later in this disclosure. In one example, a same value M(i) is used across candidate cells, i.e., M(i)=M for i=0, . . . , N−1. In one example, M(i) can change across the candidate cells.

In the first step of FIG. 14, the network configures one or more conditions for transmission on UL resource towards a candidate cell.

In one example, a condition can be based on RSRP of a signal from a candidate cell. In one example, a condition can be based on RSRQ of a signal from a candidate cell. In one example, a condition can be based on RSRP of a signal from a candidate cell. The RSRP or RSRQ or SINR are referred as a metric.

In one example, the signal used to measure the metric is SS/PBCH Block of a candidate cell. In one example, the network configures with the UE with one or more SS/PBCH blocks of one or more candidate cells for metric measurement.

In one example, the signal used to measure the metric is CSI-RS of a candidate cell. In one example, the network configures with the UE with one or more CSI-RS resources of one or more candidate cells for metric measurement.

In one example, the signals to measure a metric for a candidate cell can be configured by higher layer signaling (e.g., SIB-based signaling (for example SIB1) or RRC signaling). The signals to measure a metric for a candidate cell can be updated or activated by dynamic signaling (e.g., MAC CE signaling or L1 control signaling). In one example, the signals to measure for transmission of UL signal to a candidate cell, are the same as the signals the UE measures for a measurement report (e.g., measurement report for mobility or handover or beam management). In one example, the signals to measure for transmission of UL signal to a candidate cell, are a subset of the signals the UE measures for a measurement report (e.g., measurement report for mobility or handover or beam management). In one example, the candidate cells for UL transmission are the same as the cells measured for a measurement report (e.g., measurement report for mobility or handover or beam management). In one example, the candidate cells for UL transmission are a subset of the cells measured for a measurement report (e.g., measurement report for mobility or handover or beam management).

In one example, the condition is based on a threshold X. In one example, the network configures the UE with a threshold X, wherein the threshold X is common for candidate cells and signals used for measurement within the candidate cells. In one example, the network configures the UE with a threshold X (Y) for candidate cell Y for SS/PBCH blocks, for example, Y=0, . . . , N−1, where N is the number of candidate cells. In one example, the network configures the UE with a threshold X (Y) for candidate cell Y for CSI-RS resources, for example, Y=0, . . . , N−1, where N is the number of candidate cells. In one example, the network configures the UE with a threshold X (Y, Z) for candidate cell Y for SS/PBCH block Z of candidate cell Y, for example, Y=0, . . . , N−1, where N is the number of candidate cells, and Z=0, . . . , M−1, where M is the number of SS/PBCH blocks for candidate cell Y. In one example, the network (e.g., the network 130) configures the UE with a threshold X (Y, Z) for candidate cell Y for CSI-RS resource Z of candidate cell Y for example, Y=0, . . . , N−1, where N is the number of candidate cells, and Z=0, . . . , M−1, where M is the number of CSI-RS resources for candidate cell Y.

In one example, the threshold, e.g., X or X (Y) or X (Y,Z) can be configured by higher layer signaling (e.g., SIB-based signaling (for example SIB1) or RRC signaling). In one example, the threshold, e.g., X or X (Y) or X (Y,Z) can be updated by dynamic signaling (e.g., MAC CE signaling or L1 control signaling).

In one example, multiple values of the threshold X or X (Y) or X (Y,Z) are configured based on a parameter(s) U. i.e., the threshold configured can be
X (U), where X is a function of U.
X (Y,U), where X is a function of Y (candidate cell) and U.
X (Y,Z,U), where X is a function of Y (candidate cell), Z (signal of candidate cell) and U.

In one example, U can be based on one or more of:
UE power category, e.g., PC2 or PC3
Number of Rx antennas per UE, e.g., 2 or 4 or 6 or 8.
Number of Tx antennas per UE, e.g., 2 or 4 or 6 or 8.
Pair of number of Tx antennas and number of Rx antennas.

In a second step of FIG. 14, the UE evaluates the condition.

In one example, the condition can be a metric of a candidate cell is greater than a threshold.

In one example, the condition can be the metric of a candidate cell is greater than or equal to a threshold.

In one example, the condition can be the ratio of the metric of a candidate cell and corresponding metric of the serving is greater than a threshold. Wherein the network configures the UE to measure the metric on the serving (e.g., on a signal, e.g., SS/PBCH or CSI-RS of the serving cell), in one example, the signal, e.g., SS/PBCH or CSI-RS of the serving cell, can be associated with the main or indicated or unified TCI state.

In one example, the condition can be the ratio of the metric of a candidate cell and corresponding metric of the serving is greater than or equal to a threshold. Wherein the network configures the UE to measure the metric on the serving (e.g., on a signal, e.g., SS/PBCH or CSI-RS of the serving cell), in one example, the signal, e.g., SS/PBCH or CSI-RS of the serving cell, can be associated with the main or indicated or unified TCI state.

In one example, the condition can be the difference of the metric of a candidate cell and corresponding metric of the serving is greater than a threshold. In one example, the threshold is in dB. Wherein the network configures the UE to measure the metric on the serving (e.g., on a signal, e.g., SS/PBCH or CSI-RS of the serving cell), in one example, the signal, e.g., SS/PBCH or CSI-RS of the serving cell, can be associated with the main or indicated or unified TCI state.

In one example, the condition can be the difference of the metric of a candidate cell and corresponding metric of the serving is greater than or equal to a threshold. In one example, the threshold is in dB. Wherein the network configures the UE to measure the metric on the serving (e.g., on a signal, e.g., SS/PBCH or CSI-RS of the serving cell), in one example, the signal, e.g., SS/PBCH or CSI-RS of the serving cell, can be associated with the main or indicated or unified TCI state. In the aforementioned examples, the association can be through a QCL relation (e.g., Type-D) or a spatial relation.

In one example, two thresholds are configured, a first threshold and a second threshold. Wherein, the condition is to satisfy both condition A and condition B.

In one example, condition A can be a metric of a candidate cell is greater than the first threshold.

In one example, condition A can be the metric of a candidate cell is greater than or equal to the first threshold.

In one example, condition B can be the ratio of the metric of a candidate cell and corresponding metric of the serving is greater than the second threshold.

In one example, condition B can be the ratio of the metric of a candidate cell and corresponding metric of the serving is greater than or equal to the second threshold.

In one example, condition B can be the difference of the metric of a candidate cell and corresponding metric of the serving is greater than the second threshold. In one example, the threshold is in dB.

In one example, condition B can be the difference of the metric of a candidate cell and corresponding metric of the serving is greater than or equal to the second threshold. In one example, the threshold is in dB.

In one example, condition B can be the metric of the serving cell is less than the second threshold.

In one example, condition B can be the metric of the serving cell is less or equal to the second threshold.

In one example, two thresholds are configured, a first threshold and a second threshold. Wherein, the condition is to satisfy at least one of condition A and condition B.

In one example, condition A can be a metric of a candidate cell is greater than the first threshold.

In one example, condition A can be the metric of a candidate cell is greater than or equal to the first threshold.

In one example, condition B can be the ratio of the metric of a candidate cell and corresponding metric of the serving is greater than the second threshold.

In one example, condition B can be the ratio of the metric of a candidate cell and corresponding metric of the serving is greater than or equal to the second threshold.

In one example, condition B can be the difference of the metric of a candidate cell and corresponding metric of the serving is greater than the second threshold. In one example, the threshold is in dB.

In one example, condition B can be the difference of the metric of a candidate cell and corresponding metric of the serving is greater than or equal to the second threshold. In one example, the threshold is in dB.

In one example, condition B can be the metric of the serving cell is less than the second threshold.

In one example, condition B can be the metric of the serving cell is less or equal to the second threshold.

In a variant of the examples, “greater than” or “less than” can be replaced by “less than” or “greater than” respectively.

In the examples described herein, the metric of the serving can be one of:
In one example, the metric measured using a SS/PBCH block of the serving cell corresponding (e.g., through quasi-co-location) to an indicated or unified DL TCI state.
In one example, the metric measured using a SS/PBCH block of the serving cell corresponding (e.g., through quasi-co-location) to an indicated or unified UL TCI state.
In one example, the metric measured using a SS/PBCH block of the serving cell corresponding (e.g., through quasi-co-location) to an indicated or unified joint TCI state.
In one example, the metric measured using a SS/PBCH block of the serving cell corresponding to the SS/PBCH block with the largest metric.
In one example, the metric measured using a CSI-RS resource of the serving cell corresponding (e.g., through quasi-co-location) to an indicated or unified DL TCI state.
In one example, the metric measured using a CSI-RS resource of the serving cell corresponding (e.g., through quasi-co-location) to an indicated or unified UL TCI state.
In one example, the metric measured using a CSI-RS resource of the serving cell corresponding (e.g., through quasi-co-location) to an indicated or unified joint TCI state.
In one example, the metric measured using a CSI-RS resource of the serving cell corresponding to the CSI-RS resource with the largest metric.

In the examples described herein, the metric of a candidate cell can be evaluated over the configured or updated or activated signals (e.g., SS/PBCH blocks and CSI-RS resources) of the candidate cell. In one example, the signals to measure for transmission of UL signal to a candidate cell, are the same as the signals the UE measures for a measurement report (e.g., measurement report for mobility or handover or beam management). In one example, the signals to measure for transmission of UL signal to a candidate cell, are a subset of the signals the UE measures for a measurement report (e.g., measurement report for mobility or handover or beam management).

In the examples described herein, the metric can be evaluated over the configured or updated or activated candidate cells. In one example, the candidate cells for UL transmission are the same as the cells measured for a measurement report (e.g., measurement report for mobility or handover or beam management). In one example, the candidate cells for UL transmission are a subset of the cells measured for a measurement report (e.g., measurement report for mobility or handover or beam management). In one example, the candidate cells or the candidate cells and associated signals the UE evaluates for transmitting the associated scheduling request can be indicated by L1 control (e.g., DCI signaling) and/or can be activated by MAC CE signaling.

In a third step of FIG. 14, when a condition is satisfied the UE transmits one or more scheduling requests for UL transmissions to one or more respective candidate cells.

In one example, when a condition is satisfied corresponding to candidate cell Y, the UE transmits a scheduling request corresponding to candidate cell Y. In one example, the scheduling request is transmitted to the serving cell. In one example, the scheduling request is transmitted to candidate cell Y.

In one example, when a condition is satisfied corresponding to candidate cell Y and signal (e.g., SS/PBCH block or CSI-RS resource) Z of candidate cell Y, the UE transmits a scheduling request corresponding to candidate cell Y and signal Z. In one example, the scheduling request is transmitted to the serving cell. In one example, the scheduling request is transmitted to candidate cell Y. In one example, the scheduling request is transmitted to the serving cell. In one example, the scheduling request is transmitted to candidate cell Y using a TCI state or a spatial relation or spatial domain filter corresponding to signal Z.

In one example, the cells are in a same TAG, and the UE can use the TA of the serving cell for a transmission of the scheduling request towards a candidate cell.

In one example, the scheduling request is transmitted to a candidate cell, the UE estimates the transmission time based on the difference between the arrival time of a signal from a candidate cell and the arrival time of a signal from the serving cell. In one example, this can be as described the '085 application.

In one example, the scheduling request is transmitted once.

In one example, the scheduling request is repeated K times (or repeated within a time interval I) with a period T, wherein K and/or I and/or T can be configured and/or updated by RRC signaling and/or MAC CE signaling and/or L1 control signaling.

In one example, the scheduling is repeated with a period T until deactivated, wherein T can be configured and/or updated by RRC signaling and/or MAC CE signaling and/or L1 control signaling. In one example, the deactivation can be by RRC signaling or MAC CE signaling or L1 control signaling. In one example, the deactivation signal is from the serving cell. In one example, the deactivation signal is from the candidate cell.

In one example, the scheduling is repeated until the UE is granted UL transmission resource. In a variant example, the repetition can be up to K times (or up to interval I), wherein K or I is as aforementioned. In a variant example, the repetition can be with a period T, wherein T is as aforementioned. In a variant example, the repetition can be with a period T and up to K times (or up to interval I), wherein T and K and I are as aforementioned.

In one example, the scheduling request is transmitted using a PUCCH.

In one example, the scheduling request is transmitted using a PRACH.

In one example, the scheduling request can indicate a quantized range for (1) the metric of a candidate cell, or (2) for the ratio of the metric of a candidate cell and corresponding metric of a serving cell, or (3) for the difference between the metric of a candidate cell and the corresponding metric of a serving cell (e.g., the metric can be in dB). In one example, multiple scheduling request resources (e.g., multiple PUCCH resources or multiple preamble index) can be configured for candidate cell Y, wherein a scheduling request resource can correspond to a quantized range. In one example, multiple scheduling request resources (e.g., multiple PUCCH resources or multiple preamble index) can be configured for candidate cell Y and signal (e.g., SS/PBCH block or CSI-RS) resource Z, wherein a scheduling request resource can correspond to a quantized range.

In one example, the UE transmits scheduling request associated with M or up to M candidate cells (or candidate cell-signal pairs). For example, M candidate cells (or candidate cell-signal pairs) with the largest metrics, and/or up to M candidate cells (or candidate cell-signal pairs) with the largest metrics and the metric exceeds a threshold as aforementioned. As aforementioned, the metric can be RSRP or SINR or RSRQ. In one example, M can be defined in the system specifications and/or configured or updated by RRC signaling and/or MAC CE signaling and/or L1 control signaling. In one example, the candidate cells or the candidate cell-signal pairs the UE evaluates for transmitting the associated UL resource(s) can be indicated by L1 control (e.g., DCI signaling) and/or can be activated by MAC CE signaling.

In a fourth step of FIG. 14, the network can allocate UL resource for transmission towards a candidate or neighbor cell. In one example, the network can allocate one or more UL resources for transmission towards one or more respective candidate or neighbor cells.

In one example, the allocated resource is conveyed in downlink control information. In one example, the allocated resource is conveyed on a PDCCH, e.g., using a downlink control information (DCI) format. In one example, the allocated resource is conveyed in downlink control information carried on PDSCH. In one example, the allocated resource is conveyed by a PDDCH order. In one example, the PDCCH order can trigger a PRACH transmission. In one example, the PDCCH order can trigger a PRACH transmission not followed by an SRS transmission. In one example, the PDCCH order can trigger a PRACH transmission followed by an SRS transmission (e.g., with or without a RAR response after the PRACH transmission).

In one example, the allocated resource is conveyed using a MAC CE.

In one example, the allocated resource can be indicated by random access response.

In one example, the allocated resource is indicated as an index to a configured resource, wherein the configuration can be as aforementioned. In one example, the resource can be a SRS resource or a PRACH resource as aforementioned.

In one example, the allocated resource is a SRS transmission and indicated by one or more of the following:
Time domain resources. This can include one or more of the following parameters:
   Periodicity of SRS. The periodicity can be in units of time, e.g., symbols or slots or sub-frames of frames.
   Offset of SRS within the periodicity. The offset can be in units of time, e.g., symbols or slots or sub-frames or frames. In one example, the periodicity can be such that the start of each period (e.g., with offset 0) is aligned with the start of slot 0 of the frame with system frame number (SFN) equal to 0.
   Number of time units, e.g., symbols for SRS transmission within a slot or subframe or frame.
   Location of time units, e.g., symbols for SRS transmission within a slot or a subframe or frame. In one example, the location can be an offset of the first or last SRS symbol relative to the start or end of a slot or subframe or frame.
Frequency domain resources. This can include one or more of the following parameters:
   The start of the SRS transmission in frequency domain. In one example, this can be the first sub-carrier of SRS. In one example, this can be the first PRB of SRS. In one example, the start is offset in sub-carriers or in PRBs relative to the start or the center or the end of a BWP. In one example, the start is offset in sub-carriers or in PRBs relative to the start or the center or the end of a carrier.
   The end of the SRS transmission in frequency domain. In one example, this can be the last sub-carrier of SRS. In one example, this can be the last PRB of SRS. In one example, the end is offset in sub-carriers or in PRBs relative to the start or the center or the end of a BWP. In one example, the end is offset in sub-carriers or in PRBs relative to the start or the center or the end of a carrier.
   The size (e.g., frequency span) of the SRS transmission in frequency domain. In one example, this is given in number of PRBs. In one example, this is given in number of sub-carriers.
   The comb-size. In one example, the SRS is transmitted using a comb structure, where every Nth sub-carrier (or every Nth PRB) is transmitted, this can correspond to comb size N (or comb-N). In one example, N can be one of {1, 2, 3, 4, 6, 8 or 12}.
   The comb-offset. In one example, for a comb-N, the comb offset can be an integer from 0 to N−1. In one example, a symbol dependent offset can be added to the comb to get a symbol dependent comb offset.
Code domain resources. In one example, this can include a sequence index for the SRS sequence.
TCI state or spatial relation information.

In one example, one or more of the parameters described herein can be configured by higher layer (e.g., RRC signaling).

In one example, the allocated resource is a PRACH transmission and is indicated using a PDCCH order. The PDCCH order can indicate one or more of the following:
Random access preamble
SS/PBCH index or CSI-RS resource index
PRACH mask index
Candidate cell index
Timing advance indicator.

In the one example, the PRACH resource is not followed by SRS transmission.

In the one example, the PRACH resource is followed by SRS transmission (with or without a RAR response after the PRACH transmission).

In a fifth step of FIG. 14, when a UE receives a scheduling grant the UE transmits on a corresponding UL resource. In one example, a UE receives one or more scheduling grants the UE transmits on one or more corresponding UL resources to one or more respective candidate cells.

In one example, when a scheduling grant corresponds to candidate cell Y, the UE transmits on the UL resource corresponding to candidate cell Y.

In one example, when a scheduling grant corresponds to candidate cell Y and signal (e.g., SS/PBCH block or CSI-RS resource) Z of candidate cell Y, the UE transmits on the UL resource corresponding to candidate cell Y and signal Z.

In one example, when a scheduling grant corresponds to candidate cell Y and signal (e.g., SS/PBCH block or CSI-RS resource) Z of candidate cell Y, the UE transmits on the UL resource corresponding to candidate cell Y using a TCI state or a spatial relation or spatial domain filter corresponding to signal Z.

In one example, the UL transmission is an SRS transmission.

In one example, the UL transmission is a PRACH transmission.

In one example, the UL transmission is a PRACH transmission is followed by a SRS transmission.

In one example with reference to FIG. 12, the PRACH transmission and SRS transmission follow a Type-1 like random access procedure, wherein the network receives the PRACH and sends a random access response. In one example, the random access response includes a grant for the SRS transmission, including the resources to use. In one example, the random access response includes a TA command for the SRS transmission. In one example, RAR can be transmitted from serving cells. In one example, RAR can be transmitted from candidate cell. In one example, PRACH is transmitted towards candidate cell e.g., using a spatial filter associated with candidate cell. In one example, PRACH is transmitted towards serving cell, e.g., using a spatial filter associated with serving cell.

In one example with reference to FIG. 13, the PRACH transmission and SRS transmission follow a Type-2 like random access procedure, wherein the UL transmission includes a PRACH transmission followed by a SRS transmission. In one example, PRACH is transmitted towards candidate cell e.g., using a spatial filter associated with candidate cell. In one example, PRACH is transmitted towards serving cell, e.g., using a spatial filter associated with serving cell.

In one example, the network provides a timing command for the UL transmission, the UE uses the timing command to adjust the timing of the uplink transmission.

In one example, the cells are in a same TAG, and the UE can use the TA of the serving cell for a transmission associated with a candidate cell.

In one example, the UE (e.g., the UE 116) estimates the transmission time based on the difference between the arrival time of a signal from a candidate cell and the arrival time of a signal from the serving cell. In one example, this can be as described in the '085 application.

In one example, the UL transmission is transmitted once.

In one example, the UL transmission is repeated K times (or repeated within a time interval I) with a period T, wherein K and/or I and/or T can be configured and/or updated by RRC signaling and/or MAC CE signaling and/or L1 control signaling.

In one example, the UL transmission is repeated with a period T until deactivated, wherein T can be configured and/or updated by RRC signaling and/or MAC CE signaling and/or L1 control signaling. In one example, the deactivation can be by RRC signaling or MAC CE signaling or L1 control signaling. In one example, the deactivation signal is from the serving cell. In one example, the deactivation signal is from the candidate cell.

FIG. 15 illustrates a flowchart of an example procedure 1500 for UL resource transmission according to embodiments of the present disclosure. For example, procedure 1500 for UL resource transmission can be performed by the UE 116 and the gNB 103 and/or network 130 in the wireless network 100 of FIG. 1. This example is for illustration only and other embodiments can be used without departing from the scope of the present disclosure.

The procedure begins in 1510, a network configures resources for UL transmission. In 1520, the network allocates resources towards candidate cells. In 1530, the UE transmits on resources. The network can evaluate and compare the UL channel condition to the source cell and the candidate cell(s) based on the resource(s) transmitted by the UE. The network can, based on the evaluation and comparison, make a decision whether or not to perform a handover or cell switch from the serving cell to a candidate cell.

In a third embodiment a network triggers a UE to transmit an UL transmission towards a candidate cell. With reference to FIG. 15 an example of a procedure for the third embodiment is shown.

In a first step of FIG. 15, the network (e.g., the network 130) can configure UL resource for transmission towards one or more candidate or neighbor cells.

In one example, the configured resources are for sounding reference (SRS) signal. In one example, SRS is associated with a candidate cell. In one example, a SRS is associated with a candidate cell and a signal (e.g., SS/PBCH block or CSI-RS) associated with the candidate cell. The configuration of the SRS can include one or more of the following parameters:
Time domain resources. This can include one or more of the following parameters:
   Periodicity of SRS. The periodicity can be in units of time, e.g., symbols or slots or sub-frames of frames.
   Offset of SRS within the periodicity. The offset can be in units of time, e.g., symbols or slots or sub-frames or frames. In one example, the periodicity can be such that the start of each period (e.g., with offset 0) is aligned with the start of slot 0 of the frame with system frame number (SFN) equal to 0.
   Number of time units, e.g., symbols for SRS transmission within a slot or subframe or frame.
   Location of time units, e.g., symbols for SRS transmission within a slot or a subframe or frame. In one example, the location can be an offset of the first or last SRS symbol relative to the start or end of a slot or subframe or frame.
Frequency domain resources. This can include one or more of the following parameters:
   The start of the SRS transmission in frequency domain. In one example, this can be the first sub-carrier of SRS. In one example, this can be the first PRB of SRS. In one example, the start is offset in sub-carriers or in PRBs relative to the start or the center or the end of a BWP. In one example, the start is offset in sub-carriers or in PRBs relative to the start or the center or the end of a carrier.
   The end of the SRS transmission in frequency domain. In one example, this can be the last sub-carrier of SRS. In one example, this can be the last PRB of SRS. In one example, the end is offset in sub-carriers or in PRBs relative to the start or the center or the end of a BWP. In one example, the end is offset in sub-carriers or in PRBs relative to the start or the center or the end of a carrier.
   The size (e.g., frequency span) of the SRS transmission in frequency domain. In one example, this is given in number of PRBs. In one example, this is given in number of sub-carriers.
   The comb-size. In one example, the SRS is transmitted using a comb structure, where every Nth sub-carrier (or every Nth PRB) is transmitted, this can correspond to comb size N (or comb-N). In one example, N can be one of {1, 2, 3, 4, 6, 8 or 12}.
   The comb-offset. In one example, for a comb-N, the comb offset can be an integer from 0 to N−1. In one example, a symbol dependent offset can be added to the comb to get a symbol dependent comb offset.
Code domain resources. In one example, this can include a sequence index for the SRS sequence.
TCI state or spatial relation information. In one example, a SRS resource can be linked through a spatial relation or TCI state to an SS/PBCH block or CSI-RS of a candidate cell. In one example, an SRS resource is configured for each (or for each of a subset) of SS/PBCH blocks or CSI-RS resources of a candidate cell. In one example, an SRS resource is configured for each (or for a subset) of SS/PBCH blocks or CSI-RS resources for a candidate cell, it can be up to the UE to decide on the spatial relation and select one SS/PBCH blocks or CSI-RS (from each or from a subset of SS/PBCH blocks or CSI-RS resources respectively) for the spatial domain transmission filter of the SRS.

In one example, a list of SRS resources S(i), with i=0, . . . , N−1, is configured, for N candidate cells. Wherein, SRS resource S(i) is for candidate cell i.

In one example, a list of SRS resources S(i, j), with i=0, . . . , N−1, and j=0, . . . , M(i−1)−1 is configured for each of N candidate cells and M(i) signals (e.g., SS/PBCH blocks or CSI-RS resources) for candidate cell i. Wherein, SRS resource S(i, j) is for candidate cell i and signal j, and the signal is used by UE when measuring a metric and evaluating the metric as described later in this disclosure. In one example, a same value M(i) is used across candidate cells, i.e., M(i)=M for i=0, . . . , N−1. In one example, M(i) can change across the candidate cells.

In one example, the configured resources are for physical random access channel (PRACH). In one example, a PRACH is associated with a candidate cell. In one example, a PRACH is associated with a candidate cell and a signal (e.g., SS/PBCH block or CSI-RS) associated with the candidate cell. The configuration of the PRACH can include one or more of the following parameters:
Time domain resources. This can include one or more of the following parameters:
   Periodicity of PRACH. The periodicity can be in units of time, e.g., symbols or slots or sub-frames of frames.
   Offset of PRACH within the periodicity. The offset can be in units of time, e.g., symbols or slots or sub-frames or frames. In one example, the periodicity can be such that the start of each period (e.g., with offset 0) is aligned with the start of slot 0 of the frame with system frame number (SFN) equal to 0.
   Number of time units, e.g., symbols for PRACH transmission within a slot or subframe or frame.
   PRACH preamble format. In one example, the PRACH preamble format can indicate the number of time units, e.g., symbols or slots used for PRACH.
   Location of time units, e.g., symbols or PRACH occasions (ROs) for PRACH transmission within a slot or a subframe or frame. In one example, the location can be an offset of the first or last SRS symbol relative to the start or end of a slot or subframe or frame.
Frequency domain resources. This can include one or more of the following parameters:
   The start of the PRACH transmission in frequency domain. In one example, this can be the first sub-carrier of PRACH. In one example, this can be the first PRB of PRACH. In one example, the start is offset in sub-carriers or in PRBs relative to the start or the center or the end of a BWP. In one example, the start is offset in sub-carriers or in PRBs relative to the start or the center or the end of a carrier.
   The end of the PRACH transmission in frequency domain. In one example, this can be the last sub-carrier of PRACH. In one example, this can be the last PRB of PRACH. In one example, the end is offset in sub-carriers or in PRBs relative to the start or the center or the end of a BWP. In one example, the end is offset in sub-carriers or in PRBs relative to the start or the center or the end of a carrier.
   The PRACH Occasion in frequency domain.
   The size (e.g., frequency span) of the PRACH transmission in frequency domain. In one example, this is given in number of PRBs. In one example, this is given in number of sub-carriers. In one example, this is determined based on the preamble format. In one example, this is determined based on the sub-carrier spacing of PRACH. In one example, this is determined based on the sub-carrier spacing of the UL BWP.
Code domain resources. This can include one or more of the following:
   In one example, this can include a root sequence index to use for PRACH.
   In one example, this can include a cyclic shift sequence index in a root sequence to use for PRACH.
   In one example, this can include the PRACH or preamble sequence index.
TCI state or spatial relation information.
   In one example, a PRACH resource can be linked through a spatial relation or TCI state to an SS/PBCH block or CSI-RS of a candidate cell. In one example, a PRACH resource is configured for each (or for each of a subset) of SS/PBCH blocks or CSI-RS resources of a candidate cell. In one example, a PRACH resource is configured for each (or for a subset) of SS/PBCH blocks or CSI-RS resources for a candidate cell, it can be up to the UE decide on the spatial relation and select one SS/PBCH blocks or CSI-RS resources (from each or from a subset of SS/PBCH blocks or CSI-RS resources respectively) for the spatial domain transmission filter of the PRACH.
   In one example, an association pattern is configured for PRACH of a candidate cell. The association pattern is between PRACH preambles and ROs and SS/PBCH blocks or CSI-RS resources of candidate cells. A UE selects a preamble within an RO based on the associated SS/PBCH block or CSI-RS.

In one example, a list of PRACH resources S(i), with i=0, . . . , N−1, is configured, for N candidate cells. Wherein, PRACH resource S(i) is for candidate cell i.

In one example, a list of PRACH resources S(i, j), with i=0, . . . , N−1, and j=0, . . . , M(i−1)−1 is configured for each of N candidate cells and M(i) signals (e.g., SS/PBCH blocks or CSI-RS resources) for candidate cell i. Wherein, PRACH resource S(i, j) is for candidate cell i and signal j, and the signal is used by UE when measuring a metric and evaluating the metric as described later in this disclosure. In one example, a same value M(i) is used across candidate cells, i.e., M(i)=M for i=0, . . . , N−1. In one example, M(i) can change across the candidate cells.

In one example, a PRACH configuration is provided for N candidate cells. The PRACH configuration includes the preamble configuration (e.g., format and sequence), the PRACH Occasions configuration (e.g., in time and frequency) and the association of PRACH occasions and preambles to SS/PBCH blocks of the corresponding candidate cell.

In a second step of FIG. 15, the network can allocate UL resource for transmission towards a candidate or neighbor cell. In one example, the network can allocate one or more UL resources for transmission towards one or more respective candidate or neighbor cells.

In one example, the allocated resource is conveyed in downlink control information. In one example, the allocated resource is conveyed on a PDCCH, e.g., using a downlink control (DCI) information format. In one example, the allocated resource is conveyed in downlink control information carried on PDSCH. In one example, the allocated resource is conveyed by a PDDCH order. In one example, the PDCCH order can trigger a PRACH transmission. In one example, the PDCCH order can trigger a PRACH transmission not followed by an SRS transmission. In one example, the PDCCH order can trigger a PRACH transmission followed by an SRS transmission (e.g., with or without a RAR response after the PRACH transmission).

In one example, the allocated resource is conveyed using a MAC CE.

In one example, the allocated resource can be indicated by random access response.

In one example, the allocated resource is indicated as an index to a configured resource, wherein the configuration can be as aforementioned. In one example, the resource can be a SRS resource or a PRACH resource as aforementioned.

In one example, the allocated resource is a SRS transmission and indicated by one or more of the following:
Time domain resources. This can include one or more of the following parameters:
   Periodicity of SRS. The periodicity can be in units of time, e.g., symbols or slots or sub-frames of frames.
   Offset of SRS within the periodicity. The offset can be in units of time, e.g., symbols or slots or sub-frames or frames. In one example, the periodicity can be such that the start of each period (e.g., with offset 0) is aligned with the start of slot 0 of the frame with system frame number (SFN) equal to 0.
   Number of time units, e.g., symbols for SRS transmission within a slot or subframe or frame.
   Location of time units, e.g., symbols for SRS transmission within a slot or a subframe or frame. In one example, the location can be an offset of the first or last SRS symbol relative to the start or end of a slot or subframe or frame.
Frequency domain resources. This can include one or more of the following parameters:
   The start of the SRS transmission in frequency domain. In one example, this can be the first sub-carrier of SRS. In one example, this can be the first PRB of SRS. In one example, the start is offset in sub-carriers or in PRBs relative to the start or the center or the end of a BWP. In one example, the start is offset in sub-carriers or in PRBs relative to the start or the center or the end of a carrier.
   The end of the SRS transmission in frequency domain. In one example, this can be the last sub-carrier of SRS. In one example, this can be the last PRB of SRS. In one example, the end is offset in sub-carriers or in PRBs relative to the start or the center or the end of a BWP. In one example, the end is offset in sub-carriers or in PRBs relative to the start or the center or the end of a carrier.
   The size (e.g., frequency span) of the SRS transmission in frequency domain. In one example, this is given in number of PRBs. In one example, this is given in number of sub-carriers.
   The comb-size. In one example, the SRS is transmitted using a comb structure, where every Nth sub-carrier (or every Nth PRB) is transmitted, this can correspond to comb size N (or comb-N). In one example, N can be one of {1, 2, 3, 4, 6, 8 or 12}.
   The comb-offset. In one example, for a comb-N, the comb offset can be an integer from 0 to N−1. In one example, a symbol dependent offset can be added to the comb to get a symbol dependent comb offset.
Code domain resources. In one example, this can include a sequence index for the SRS sequence.
TCI state or spatial relation information.

In one example, one or more of the parameters described herein can be configured by higher layer (e.g., RRC signaling).

In one example, the allocated resource is a PRACH transmission and is indicated using a PDCCH order. The PDCCH order can indicate one or more of the following:
Random access preamble
SS/PBCH index or CSI-RS resource index
PRACH mask index
Candidate cell index
Timing advance indicator.

In the one example, the PRACH resource is not followed by SRS transmission.

In the one example, the PRACH resource is followed by SRS transmission (with or without a RAR response after the PRACH transmission).

In a third step of FIG. 15, when a UE receives a scheduling grant the UE transmits on a corresponding UL resource. In one example, a UE receives one or more scheduling grants the UE transmits on one or more corresponding UL resources to one or more respective candidate cells.

In one example, when a scheduling grant corresponds to candidate cell Y, the UE transmits on the UL resource corresponding to candidate cell Y.

In one example, when a scheduling grant corresponds to candidate cell Y and signal (e.g., SS/PBCH block or CSI-RS resource) Z of candidate cell Y, the UE transmits on the UL resource corresponding to candidate cell Y and signal Z.

In one example, when a scheduling grant corresponds to candidate cell Y and signal (e.g., SS/PBCH block or CSI-RS resource) Z of candidate cell Y, the UE transmits on the UL resource corresponding to candidate cell Y using a TCI state or a spatial relation or spatial domain filter corresponding to signal Z.

In one example, the UL transmission is an SRS transmission.

In one example, the UL transmission is a PRACH transmission.

In one example, the UL transmission is a PRACH transmission is followed by a SRS transmission.

In one example with reference to FIG. 12, the PRACH transmission and SRS transmission follow a Type-1 like random access procedure, wherein the network receives the PRACH and sends a random access response. In one example, the random access response includes a grant for the SRS transmission, including the resources to use. In one example, the random access response includes a TA command for the SRS transmission. In one example, RAR can be transmitted from serving cells. In one example, RAR can be transmitted from candidate cell. In one example, PRACH is transmitted towards candidate cell e.g., using a spatial filter associated with candidate cell. In one example, PRACH is transmitted towards serving cell, e.g., using a spatial filter associated with serving cell.

In one example with reference to FIG. 13, the PRACH transmission and SRS transmission follow a Type-2 like random access procedure, wherein the UL transmission includes a PRACH transmission followed by a SRS transmission. In one example, PRACH is transmitted towards candidate cell e.g., using a spatial filter associated with candidate cell. In one example, PRACH is transmitted towards serving cell, e.g., using a spatial filter associated with serving cell.

In one example, the network provides a timing command for the UL transmission, the UE uses the timing command to adjust the timing of the uplink transmission.

In one example, the cells are in a same TAG, and the UE can use the TA of the serving cell for a transmission associated with a candidate cell.

In one example, the UE estimates the transmission time based on the difference between the arrival time of a signal from a candidate cell and the arrival time of a signal from the serving cell. In one example, this can be as described in the '085 application.

In one example, the UL transmission is transmitted once.

In one example, the UL transmission is repeated K times (or repeated within a time interval I) with a period T, wherein K and/or I and/or T can be configured and/or updated by RRC signaling and/or MAC CE signaling and/or L1 control signaling.

In one example, the UL transmission is repeated with a period T until deactivated, wherein T can be configured and/or updated by RRC signaling and/or MAC CE signaling and/or L1 control signaling. In one example, the deactivation can be by RRC signaling or MAC CE signaling or L1 control signaling. In one example, the deactivation signal is from the serving cell. In one example, the deactivation signal is from the candidate cell.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive one or more signals from one or more candidate cells,
receive, from a serving cell, information including (i) configuration for a first communication element and (ii) association of the one or more signals with the first communication element, and
receive information for a first threshold; and
a processor operably coupled to the transceiver, the processor configured to:
measure first reference signal received powers (RSRPs) for each of the one or more signals, and
evaluate a condition based on the first RSRPs and the first threshold,
wherein the transceiver is further configured to transmit, when the condition is satisfied, the first communication element to a corresponding one of the one or more candidate cells.

2. The UE of claim 1, wherein:
the transceiver is further configured to receive information for a second threshold,
the processor is further configured to measure a second RSRP of a signal from the serving cell, and
the condition is further based on the second threshold and the second RSRP.

3. The UE of claim 1, wherein:
the first communication element includes a part one and a part two, and
the transceiver is further configured to:
receive information for a time T,
transmit the part one of the first communication element based on a spatial domain transmission filter associated with the corresponding one of the one or more candidate cells, and
transmit, after the time T from the transmission of the part one of the first communication element, the part two of the first communication element using a spatial domain filter associated with the corresponding one of the one or more candidate cells.

4. The UE of claim 3, wherein:
the part one of the first communication element is a physical uplink control channel (PUCCH),
the PUCCH indicates a resource of the part two of the first communication element, and
the part two of the first communication element is a sounding reference signal (SRS).

5. The UE of claim 3, wherein:
the part one of the first communication element is a physical random access channel (PRACH),
the PRACH indicates a resource of the part two of the first communication element, and
the part two of the first communication element is a sounding reference signal (SRS).

6. The UE of claim 1, wherein the transceiver is further configured to:
receive, from the serving cell, information including (i) configuration for a second communication element and (ii) association of the one or more signals with the second communication element,
receive, from the serving cell, information including (i) configuration for a third communication element and (ii) association of the one or more signals with the third communication element,
transmit, when the condition is satisfied, the second communication element based on a spatial domain transmission filter associated with the serving cell,
receive a command to transmit the third communication element based on the transmission of the second communication element and based on a spatial domain reception filter associated with the serving cell, and
transmit the third communication element based on the reception of the command and based on a spatial domain transmission filter associated with a candidate cell.

7. The UE of claim 6, wherein:
the second communication element is a physical uplink control channel (PUCCH),
the PUCCH indicates a signal of the candidate cell that satisfies the condition, and
the third communication element is a sounding reference signal (SRS).

8. A base station (BS) system, comprising:
one or more candidate BSs comprising one or more transceivers, respectively, configured to transmit one or more signals, respectively, from one or more candidate cells, respectively; and
a serving BS comprising a transceiver and a processor operably coupled with the transceiver, the transceiver of the serving BS configured to:
transmit, from a serving cell, information including (i) configuration for a first communication element and (ii) association of the one or more signal with the first communication element, and
transmit information for a first threshold,
wherein, when a condition based on the first threshold is satisfied, one of the one or more transceivers of the one or more candidate BSs is further configured to receive the first communication element on a corresponding one of the one or more candidate cells, and
wherein the processor of the serving BS is configured to, based on measurement of the first communication element, determine whether or not to perform handover to one of the one or more candidate cells.

9. The BS system of claim 8, wherein:
the transceiver of the serving BS is further configured to transmit information for a second threshold, and
the condition is further based on the second threshold.

10. The BS system of claim 8, wherein:
the first communication element includes a part one and a part two,
the transceiver of the serving BS is further configured to transmit information for a time T, and
the one of the one or more transceivers of the one or more candidate BSs is further configured to:
receive the part one of the first communication element on the corresponding one of the one or more candidate cells, and
receive, based on the reception of the part one of the communication element and after the time T from the reception of the part one of the communication element, the part two of the first communication element on the corresponding one of the one or more candidate cells.

11. The BS system of claim 10, wherein:
the part one of the first communication element is a physical uplink control channel (PUCCH),
the PUCCH indicates a resource of the part two of the first communication element, and
the part two of the first communication element is a sounding reference signal (SRS).

12. The BS system of claim 10, wherein:
the part one of the first communication element is a physical random access channel (PRACH),
the PRACH indicates a resource of the part two of the first communication element, and
the part two of the first communication element is a sounding reference signal (SRS).

13. The BS system of claim 8, wherein:
the transceiver of the serving BS is further configured to:
transmit, from the serving cell, information including (i) configuration for a second communication element and (ii) association of the one or more signals with the second communication element,
transmit, from the serving cell, information including (i) configuration for a third communication element and (ii) association of the one or more signals with the third communication element, and
receive the second communication element on the serving cell, and
transmit, from the serving cell, a command for transmission of the third communication element based on the reception of the second communication element, and
one of the one or more transceivers of the one or more candidate BSs is further configured to receive the third communication element on a candidate cell corresponding to the third communication element.

14. The BS system of claim 13, wherein:
the second communication element is a physical uplink control channel (PUCCH),
the PUCCH indicates a signal of the candidate cell corresponding to the second communication element, and
the third communication element is a sounding reference signal (SRS).

15. A method of operating a user equipment (UE), the method comprising:
receiving one or more signals from one or more candidate cells;
receiving, from a serving cell, information including (i) configuration for a first communication element and (ii) association of the one or more signal with the first communication element;
receiving information for a first threshold;
measuring first reference signal received powers (RSRPs) for each of the one or more signals;
evaluating a condition based on the first RSRPs and the first threshold; and
when the condition is satisfied, transmitting the first communication element to a corresponding one of the one or more candidate cells.

16. The method of claim 15, further comprising:
receiving information for a second threshold; and
measuring a second RSRP of a signal from the serving cell,
wherein the condition is further based on the second threshold and the second RSRP.

17. The method of claim 15, wherein:
the first communication element includes a part one and a part two,
the method further comprises receiving information for a time T, and
transmitting the first communication element further comprises:
transmitting the part one of the first communication element based on a spatial domain transmission filter associated with the corresponding one of the one or more candidate cells, and
transmitting, after the time T from the transmission of the part one of the first communication element, the part two of the first communication element using a spatial domain filter associated with the corresponding one of the one or more candidate cells.

18. The method of claim 17, wherein:
the part one of the first communication element is one of (i) a physical uplink control channel (PUCCH) or (ii) a physical random access channel (PRACH),
the part one of the first communication element indicates a resource of the part two of the first communication element, and
the part two of the first communication element is a sounding reference signal (SRS).

19. The method of claim 15, further comprising:
receiving, from the serving cell, information including (i) configuration for a second communication element and (ii) association of the one or more signals with the second communication element;
receiving, from the serving cell, information including (i) configuration for a third communication element and (ii) association of the one or more signals with the third communication element;
transmitting, when the condition is satisfied, the second communication element, based on a spatial domain transmission filter associated with the serving cell;
receiving a command to transmit the third communication element based on the transmission of the second communication element and based on a spatial domain reception filter associated with the serving cell; and
transmitting the third communication element based on the reception of the command and based on a spatial domain transmission filter associated with a candidate cell.

20. The method of claim 19, wherein:
the second communication element is a physical uplink control channel (PUCCH),
the PUCCH indicates a signal of the candidate cell that satisfies the condition, and
the third communication element is a sounding reference signal (SRS).
